(19) United States
(12) Patent Application Publication
(10) Pub. No.: US 2008/0159083 A1
(43) Pub. Date: Jul. 3, 2008

(54) TIMEPIECE DIAL AND TIMEPIECE

(75) Inventor: Atsushi KAWAKAMI, Suwa-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 11/956,012

(22) Filed: Dec. 13, 2007

(30) Foreign Application Priority Data
Dec. 15, 2006 (JP) 2006-339229

(51) Int. Cl. G04B 19/12

(52) U.S. Cl. 368/232

(57) ABSTRACT

A timepiece dial has a base member made of primarily polycarbonate, a titanium oxide particle dispersion layer having titanium oxide particles made of titanium oxide dispersed in a dispersion medium, and a silicon oxide particle dispersion layer having silicon oxide particles made of silicon oxide dispersed in a dispersion medium. In this timepiece dial, the titanium oxide particle dispersion layer is disposed on one side of the base member, and the silicon oxide particle dispersion layer is disposed on the other side.

### TECHNICAL FIELD

The present invention relates to a timepiece dial and to a timepiece.

### PRIOR ART

A timepiece dial requires both excellent readability as a utilitarian product and an excellent appearance as a decorative product. As a result, Au, Ag, and other metal materials are commonly used to manufacture timepiece dials.

In order to reduce the production cost and to improve freedom in molding the timepiece dial, attempts have also been made to use a plastic base member on which a metal coating is formed. (See, for example, patent reference 1.)

Plastic, however, generally suffers from poor adhesion with metal materials. As a result, separation between the base material and the coating occurs easily, and the timepiece dial suffers from poor durability.

The timepiece dial must also be able to transmit electromagnetic waves (radio waves and light) in radio-controlled timepieces and solar timepieces (timepieces that have a solar cell). Plastic has therefore been used for such timepiece dials, but because plastic lacks a sense of high quality, there have also been attempts to form a metallic thin film on the dial in order to improve the appearance of the timepiece dial. However, the above-described problem of poor adhesion between the plastic and metal material remains. The thickness of the thin film must also be sufficiently thin in order to improve transmittance of electromagnetic waves (radio waves and light), but this has the problem of reducing the overall visual appeal of the timepiece dial.

Patent reference 1: Japanese Unexamined Patent Appl. Pub. JP-A-2003-239083 (lines 37 to 42 of left column on page 4)

### DISCLOSURE OF INVENTION

An object of the present invention is to provide a timepiece featuring excellent transmittance of electromagnetic waves (radio waves and light) as well as an outstanding appearance and durability, and to provide a timepiece having this timepiece dial.

To achieve the foregoing object, a timepiece dial according to the present invention has a base member made of primarily polycarbonate, a titanium oxide particle dispersion layer having titanium oxide particles made of titanium oxide dispersed in a dispersion medium, and a silicon oxide particle dispersion layer having silicon oxide particles made of silicon oxide dispersed in a dispersion medium.

This arrangement enables providing a timepiece dial with outstanding transmittance of electromagnetic waves (radio waves and light), as well as an outstanding appearance and durability. More particularly, the timepiece dial has a luster that exudes high quality, and a particularly outstanding appearance.

Preferably, in the timepiece dial according to the invention the average particle diameter of the titanium oxide particles is 2-30 nm.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention the content of the titanium oxide particles in the titanium oxide particle dispersion layer is 3-35 vol %.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention the titanium oxide is rutile titanium dioxide.

This enables imparting an even more outstanding appearance to the timepiece dial while assuring sufficiently high electromagnetic wave (radio waves and light) transmittance. If the titanium oxide particles are made of an anatase-type titanium dioxide, the anatase-type titanium dioxide can work to promote the breakdown of the dispersion medium depending on the composition of the dispersion medium in the titanium oxide particle dispersion layer, but using a rutile-type titanium dioxide can reliably prevent this problem from occurring and can impart the timepiece dial with particularly outstanding durability.

Further preferably in the timepiece dial according to the invention the thickness of the titanium oxide particle dispersion layer is 0.5-30 μm.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention the average particle diameter of the silicon oxide particles is 10-250 nm.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention the content of the silicon oxide particles in the silicon oxide particle dispersion layer is 3-35 vol %.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention the thickness of the silicon oxide particle dispersion layer is 0.5-30 μm.

This enables imparting an even more outstanding appearance to the timepiece dial while assuring sufficiently high electromagnetic wave (radio waves and light) transmittance. The durability of the timepiece dial can also be made particularly outstanding.

Further preferably in the timepiece dial according to the invention, when the average particle diameter of the titanium oxide particles is D_{TO} (nm) and the average particle diameter of the silicon oxide particles is D_{SO} (nm), the relationship 3≦D_{SO}/D_{TO}≦10 is true.

This enables imparting an even more outstanding appearance to the timepiece dial while assuring sufficiently high electromagnetic wave (radio waves and light) transmittance.

Further preferably, the timepiece dial of the invention is used with the base member disposed on the viewer side of the silicon oxide particle dispersion layer.

This arrangement makes the appearance of the timepiece dial even more outstanding.

Yet further preferably in the timepiece dial of the invention, the silicon oxide particle dispersion layer is disposed on the surface on the opposite side of the base member as the surface to which the titanium oxide particle dispersion layer is disposed.

This arrangement can make the durability of the timepiece dial even more outstanding while making the appearance of the timepiece dial sufficiently outstanding.

Yet further preferably in the timepiece dial of the invention, the titanium oxide particle dispersion layer and the silicon oxide particle dispersion layer are adjoining.

This arrangement can make the appearance of the timepiece dial even more outstanding.

In addition to the base member, the titanium oxide particle dispersion layer, and the silicon oxide particle dispersion layer, the timepiece dial according to the invention further preferably also has a reflective film having openings disposed therein.

This results in a timepiece dial with an even more outstanding appearance while assuring sufficiently high electromagnetic wave (radio waves and light) transmittance.

Further preferably in the timepiece dial according to the invention, the base member has disposed on a second surface, which is on the surface on the opposite side as a first surface, which is the surface on the viewer side, fine pits and lands with a function of reflecting and scattering light incident from the first surface side.

This enables imparting an even more outstanding appearance to the timepiece dial while assuring sufficiently high electromagnetic wave (radio waves and light) transmittance.

Yet further preferably in a timepiece dial according to the invention, the color of the surface of the timepiece dial on the opposite side of the base member as the surface on the side to which the silicon oxide particle dispersion layer is disposed has an a* of −8 to 8 and a b* of −8 to 8 in the L*a*b* color space defined in JIS Z 8729.

This results in a timepiece dial with a particularly outstanding appearance.

A timepiece according to the invention is characterized by having the timepiece dial of the invention.

This enables providing a timepiece with an outstanding appearance and durability. It also enables providing a timepiece (such as a radio-controlled timepiece, a solar-powered timepiece, or a solar-powered radio-controlled timepiece) that can use external electromagnetic waves (radio waves and light) effectively.

### BRIEF DESCRIPTION OF THE DRAWINGS

FIG. 1 is a section view of a first embodiment of a timepiece dial according to the present invention.

FIG. 2 is a section view of a second embodiment of a timepiece dial according to the present invention.

FIG. 3 is a section view of a part of a preferred embodiment of a timepiece (portable timepiece) according to the present invention.

FIG. 4 is a section view of a third embodiment of a timepiece dial according to the present invention.

FIG. 5 is a section view of a fourth embodiment of a timepiece dial according to the present invention.

FIG. 6 is a schematic plan view describing an example of the shape (pattern) of the openings in the reflective film disposed to the timepiece dial in the third embodiment of the invention.

FIG. 7 is a schematic plan view describing another example of the shape (pattern) of the openings in the reflective film disposed to the timepiece dial in the third embodiment of the invention.

FIG. 8 is a schematic plan view showing an example of a surface roughness pattern formed on the base member of the timepiece dial in a fourth embodiment of the invention.

FIG. 9 is a schematic plan view showing an example of a surface roughness pattern formed on the base member of the timepiece dial in a fourth embodiment of the invention.

FIG. 10 is a schematic plan view showing an example of a surface roughness pattern formed on the base member of the timepiece dial in a fourth embodiment of the invention.

FIG. 11 is a schematic plan view showing an example of a surface roughness pattern formed on the base member of the timepiece dial in a fourth embodiment of the invention.

FIG. 12 is a schematic plan view showing an example of a surface roughness pattern formed on the base member of the timepiece dial in a fourth embodiment of the invention.

### DESCRIPTION OF PREFERRED EMBODIMENTS

Preferred embodiments of the present invention are described below with reference to the accompanying figures.

A preferred embodiment of a timepiece dial according to the present invention is described first below.

### <Timepiece Dial (First Embodiment)>

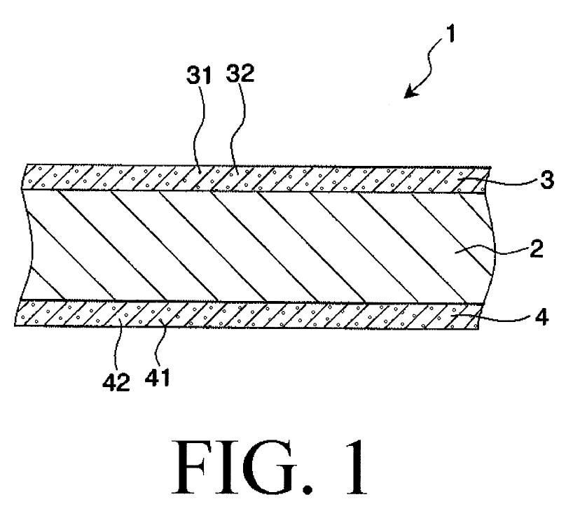

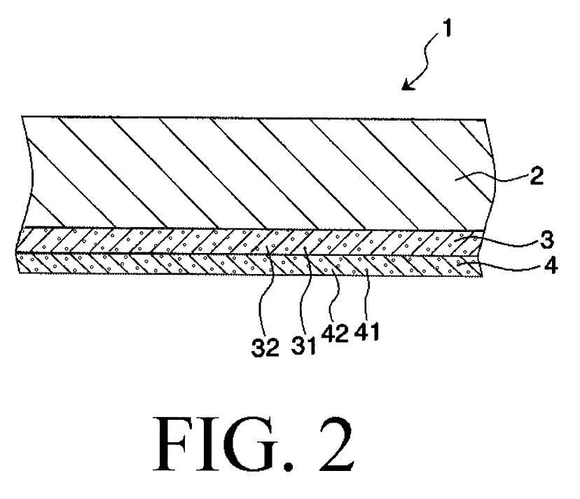

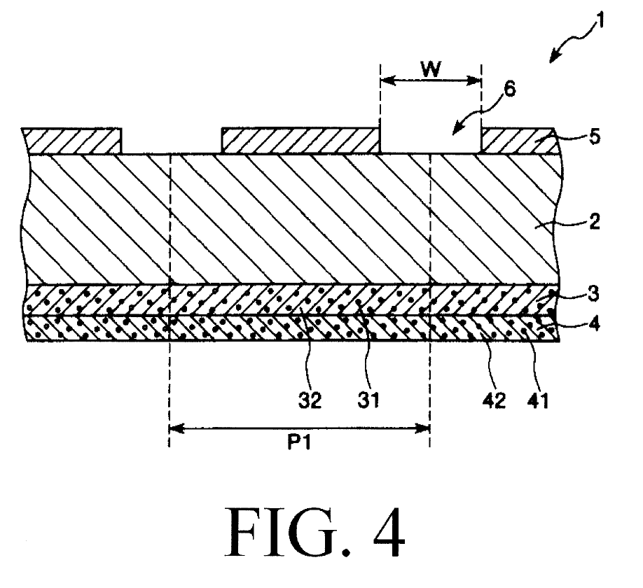

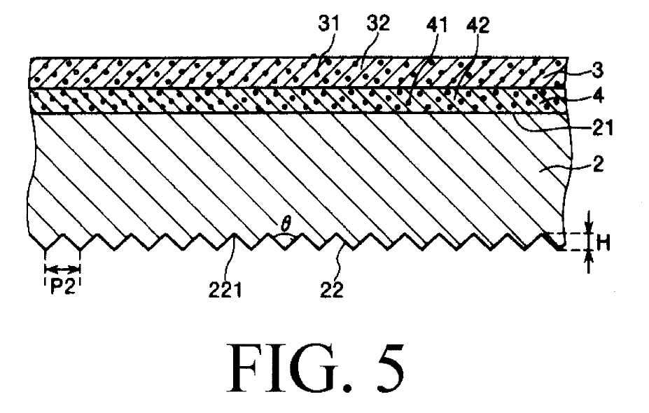

FIG. 1 is a section view showing a first embodiment of a timepiece dial according to the present invention. Note that the figures referenced in this specification emphasize a part of the configuration, and do not accurately reflect the actual dimensions, for example. The top side of the accompanying figures is also referred to as the “top” and the bottom side is referred to as the “bottom” in the following description. The timepiece dial is also described below as used with the top side in the figures being disposed on the viewer's side (that is, when the timepiece dial is used in a timepiece as described below, the movement and other parts are disposed facing the surface of the dial on the bottom in the figure) (this also applies to FIG. 2, FIG. 4, and FIG. 5).

As shown in FIG. 1, a timepiece dial 1 according to this embodiment of the invention has a base member (substrate) 2 made of primarily polycarbonate, a titanium oxide particle dispersion layer 3 having titanium oxide particles 31 made from titanium oxide dispersed in a dispersion medium 32, and a silicon oxide particle dispersion layer 4 having silicon oxide particles 41 dispersed in a dispersion medium 42. The titanium oxide particles 31 are made of primarily titanium oxide, and the silicon oxide particles 41 are made of primarily silicon oxide. The titanium oxide particle dispersion layer 3 is rendered on one side (surface) of the base member 2, and the silicon oxide particle dispersion layer 4 is rendered on the opposite side of the base member 2 as the side (surface) on which the titanium oxide particle dispersion layer 3 is disposed. “Primarily” as used herein indicates the component of the greatest content in the material composing the target part, and while not specifically limited the content is preferably greater than or equal to 60 wt %, further preferably is greater than or equal to 80 wt %, and yet further preferably is greater than or equal to 90 wt % of the material composing the target part.

The timepiece dial of the invention is normally used with the titanium oxide particle dispersion layer more to the outside than the silicon oxide particle dispersion layer, that is, on the side toward the viewer. Unless otherwise specified in the following description, the timepiece dial 1 is described as being used with the top side in the figures facing the outside.

[Base Member]

The base member 2 is made of a material containing primarily polycarbonate (PC). One essential requirement of the base member 2 of the invention is transmittance of electromagnetic waves (radio waves and light). Of the various plastic materials that are available, polycarbonate offers particularly high transparency and outstanding transmittance of electromagnetic waves, and can therefore render the base member 2 with outstanding electromagnetic wave transmittance. In addition, the difference in the refractive indices of the polycarbonate base member 2 and the titanium oxide particle dispersion layer 3 and silicon oxide particle dispersion layer 4 described below enable the desirable reflection and refraction of incident light at the interface between the base member 2 and the titanium oxide particle dispersion layer 3 and the opposite side (the bottom in the figure) of the base member 2 as the side that is coated with the titanium oxide particle dispersion layer 3. This enables imparting the timepiece dial 1 with an outstanding appearance. Polycarbonate is also resistant to deformation caused by external stress such as from light or heat. This affords particularly outstanding adhesion between the polycarbonate base member 2 and the titanium oxide particle dispersion layer 3 and silicon oxide particle dispersion layer 4 described below, and as a result renders the timepiece dial 1 with particularly outstanding durability. Furthermore, the timepiece dial 1 can also be rendered with particularly high strength by making the base member 2 from a material containing polycarbonate. In addition, because there is a greater degree of freedom molding the base member 2 (improved moldability) when manufacturing the timepiece dial 1, even a timepiece dial 1 with a complicated shape can be easily and reliably manufactured. Polycarbonate is also a relatively low cost plastic, and can help reduce the production cost of the timepiece dial 1.

The base member 2 can also contain materials other than polycarbonate. Examples of such materials include plasticizers, oxidation inhibitors, coloring agents (including colorants, fluorescent materials, and phosphorescent materials), brighteners, fillers, and resins other than polycarbonate. For example, if the base member 2 is made of a material including a colorant, the timepiece dial 1 can be rendered in more color variations.

The refractive index of the base member 2 made of primarily polycarbonate is not particularly limited, but is preferably 1.48-1.60, and further preferably 1.54-1.59. This enables more desirable reflection and refraction of light at the interface between the base member 2 and the titanium oxide particle dispersion layer 3 and at the side of the base member 2 opposite the side coated with the titanium oxide particle dispersion layer 3 (the interface between the base member 2 and the silicon oxide particle dispersion layer 4). As a result, the appearance of the timepiece dial 1 can be yet further improved. Note that in this specification the refractive index indicates the absolute refractive index at 25° C. using sodium D-lines unless specified otherwise.

The thickness of the base member 2 is not specifically limited, but is preferably 150-700 μm, further preferably 200-600 μm, and yet further preferably 300-500 μm. If the thickness of the base member 2 is within this range, the timepiece in which the timepiece dial 1 is used can be effectively prevented from becoming thick, and the timepiece dial 1 can be rendered with excellent mechanical strength and shape stability. The electromagnetic wave transmittance and appearance of the timepiece dial 1 are also generally degraded as the thickness of the base member 2 increases. However, because the refractive index of polycarbonate is low, the thickness of the base member 2 does not create a difference in the electromagnetic wave transmittance or appearance if the thickness of the base member 2 is within this range, and the timepiece dial 1 can be rendered with a sufficiently outstanding appearance and particularly outstanding electromagnetic wave transmittance.

Furthermore, while the base member 2 can be molded by any desirable method, exemplary base member 2 molding methods include compression molding, extrusion molding, and injection molding.

[Titanium Oxide Particle Dispersion Layer]

A titanium oxide particle dispersion layer 3 having titanium oxide particles 31 made from titanium oxide dispersed in a dispersion medium 32 is disposed to the surface of the base member 2.

The titanium oxide material contained in the titanium oxide particle dispersion layer 3 is a compound of Ti and O. This titanium oxide material generally has a higher refractive index than the dispersion medium 32, and the difference between the refractive indices of the titanium oxide particles 31 and the dispersion medium 32 causes incident light to be desirably reflected and refracted at the numerous interfaces between the dispersion medium 32 and the many titanium oxide particles 31 dispersed therein. In addition, the difference between the refractive index of the titanium oxide particle dispersion layer 3 and the base member 2 causes incident light to be desirably reflected and refracted at the interface between the titanium oxide particle dispersion layer 3 and the base member 2. This enables imparting a particularly good appearance to the timepiece dial 1.

While not specifically limited, the refractive index of the titanium oxide particles 31 is preferably 2.45-2.85, and is further preferably 2.55-2.80. This enables incident light to be desirably reflected and refracted at the numerous interfaces between the dispersion medium 32 and the titanium oxide particles 31, enables light to be more desirably reflected and refracted at the interface between the base member 2 and the titanium oxide particle dispersion layer 3 and at the interface between the base member 2 and the silicon oxide particle dispersion layer 4 described below, enables imparting a particularly good appearance to the timepiece dial 1.

If the refractive index of the base member 2 is n₂ and the refractive index of the titanium oxide particles 31 is n₃, the difference n₃-n₂ between the refractive indices of the titanium oxide particles 31 and the base member 2 is preferably 0.85-1.37, and further preferably is 0.96-1.26. This enables incident light to be desirably reflected and refracted at the interface between the base member 2 and the titanium oxide particle dispersion layer 3, and enables imparting a particularly good appearance to the timepiece dial 1.

As described above, the titanium oxide particles 31 can be any material primarily composed of titanium oxide, which is a compound of Ti and O. Examples of such titanium oxide materials include rutile-type titanium dioxide (TiO₂), anatase-type titanium dioxide (TiO₂), buchite-type titanium dioxide (TiO₂) titanium monoxide (TiO), and titanium trioxide (Ti₂O₃). Of these, the titanium oxide particles 31 are preferably made of rutile titanium dioxide. This affords sufficiently high transmittance of electromagnetic waves (radio waves and light) while also imparting a particularly good appearance to the timepiece dial 1. If the titanium oxide particles 31 are made of an anatase-type titanium dioxide, the anatase-type titanium dioxide can work to promote the breakdown of the dispersion medium 32 depending on the composition of the dispersion medium 32 in the titanium oxide particle dispersion layer 3, but using a rutile-type titanium dioxide can reliably prevent this problem from occurring and can impart the timepiece dial 1 with particularly outstanding durability. The occurrence of the foregoing problems can be effectively prevented particularly if the dispersion medium 32 is made from a material that is susceptible to the action of a photocatalyst, such as an acrylic resin. As a result, a particularly good appearance can be maintained for a long time.

In addition to titanium, the titanium oxide material can use oxides including other metals (such as plural oxides). The titanium oxide particles 31 could also have a surface process applied to particles made of primarily titanium oxide. This enables reliably preventing agglomeration of the titanium oxide particles 31 in the titanium oxide particle dispersion layer 3, for example, improves the dispersion properties of the titanium oxide particles 31, and enables imparting a particularly good appearance to the timepiece dial 1. Examples of surface processing methods that can be applied to the particles made of primarily titanium oxide include surface processing with HMDS, silane coupling agents (including agents having an amino group or other functional group), titanate coupling agents, fluorinated silane coupling agents, and silicone oil.

The average particle diameter of the titanium oxide particles 31 is preferably 2-30 nm, and further preferably 5-25 nm. If the average particle diameter of the titanium oxide particles 31 is within this range, incident light can be better reflected while assuring sufficiently high transmittance of electromagnetic waves (radio waves and light), and a particularly good appearance can be imparted to the timepiece dial 1. More particularly, if the average particle diameter of the titanium oxide particles 31 is greater than 30 nm, the color of the particles could become cloudy and thus degrade the appearance of the titanium oxide particle dispersion layer 3. Unless otherwise specified, the average particle diameter as used in this specification is the average particle diameter on a volume basis.

The shape of the titanium oxide particles 31 is not specifically limited, and could be substantially spherical, scale shaped, needle shaped, or any other shape. The particles could also be irregularly shaped.

The content of the titanium oxide particles 31 in the titanium oxide particle dispersion layer 3 is preferably 3-35 vol %, and further preferably 7-28 vol %. If the content of the titanium oxide particles 31 is within this range, incident light can be better reflected while assuring sufficiently high transmittance of electromagnetic waves (radio waves and light), and a particularly good appearance can be imparted to the timepiece dial 1. The titanium oxide particle dispersion layer 3 can also be imparted with excellent stability (impact resistance) to external forces such as impact force, and the overall timepiece dial 1 can be imparted with excellent durability and reliability.

The dispersion medium 32 used in the titanium oxide particle dispersion layer 3 is made from a transparent material. Examples of materials that can be used for the dispersion medium 32 include various types of resins, non-alkaline glass, soda glass, crystalline glass, quartz glass, lead glass, potassium glass, borosilicate glass, and other types of glass materials, but a resin material is preferable. This assures sufficiently high transmittance of electromagnetic waves (radio waves and light), and enables imparting a particularly good appearance to the timepiece dial 1. Furthermore, using a plastic material for the dispersion medium 32 affords superior adhesion between the titanium oxide particle dispersion layer 3 and the polycarbonate base member 2 than if a different material (such as a glass material) is used for the dispersion medium 32. The titanium oxide particle dispersion layer 3 can also be imparted with excellent stability (impact resistance) to external forces such as impact force. As a result, the overall timepiece dial 1 can be imparted with excellent durability and reliability.

Examples of plastic materials that can be used for the dispersion medium 32 include various thermoplastic resins and thermosetting resins, such as polyethylene, polypropylene, ethylene-propylene copolymer, ethylene-vinyl acetate copolymer (EVA), vinyl acetate resin and other polyolefins, cyclic polyolefins, denatured polyolefins, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylbentene-1), ionomer, acrylic resins, polymethylmethacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene vinyl alcohol copolymer (EVOH), polyethylene terephthalate (PET), polybutyleneterephthalate (PBT), polycyclohexaneterephthalate (PCT) and other polyesters, polyether, polyether ketone (PEK), polyethere therketone (PEEK), polyetherimide, polyacetal (POM), polyphenylene oxide, denatured polyphenylene oxide, polysulfone, polyethersulfone, polyphenylene sulfide, polyarylate, aromatic polyester (liquid crystal polymer), polytetrafluoroethylene, polyvinylidene fluoride, and other fluororesins, styrenes, polyolefins, polyvinyl chlorides, polyurethanes, polyesters, polyamides, polybutadienes, transpolyisoprenes, fluoroelastomers, polyethylene chlorides and other thermoplastic elastomers, epoxy resin, phenol resin, urea resin, melamine resin, unsaturated polyester, silicon resin, urethane resin, poly-para-xylylene, poly-monochloro-para-xylylene, poly-dichloro-para-xylylene, poly-monofluoro-para-xylylene, poly-monoethyl-para-xylylene, and other poly-para-xylylene resins, as well as copolymers, blends, and polymer alloys of primarily the foregoing, and one or two or more of the foregoing used together (as blended resins, polymer alloys, or laminates, for example). Of the foregoing, if the dispersion medium 32 made from an acrylic resin, a particularly good appearance can be imparted to the timepiece dial 1. Furthermore, by using an acrylic resin as the dispersion medium 32, particularly good adhesion can be achieved between the base member 2 and the titanium oxide particle dispersion layer 3, and the timepiece dial 1 can be imparted with particularly good durability.

The titanium oxide particle dispersion layer 3 can contain materials other than the above. Examples of such materials include plasticizers, oxidation inhibitors, coloring agents (including colorants, fluorescent materials, and phosphorescent materials), brighteners, and fillers. For example, if the titanium oxide particle dispersion layer 3 is made of a material including a colorant, the timepiece dial 1 can be rendered in more color variations.

The thickness of the titanium oxide particle dispersion layer 3 is not specifically limited, but is preferably 0.5-30 μm, and further preferably is 2-20 μm. If the thickness of the titanium oxide particle dispersion layer 3 is within this range, incident light can be better reflected while assuring sufficiently high transmittance of electromagnetic waves (radio waves and light), and a particularly good appearance can be imparted to the timepiece dial 1.

[Silicon Oxide Particle Dispersion Layer]

A silicon oxide particle dispersion layer 4 having silicon oxide particles 41 dispersed in a dispersion medium 42 is rendered on the opposite side of the base member 2 as the surface opposing the titanium oxide particle dispersion layer 3. By having a silicon oxide particle dispersion layer 4, light (external light) that is incident from the top as seen in the figure is emitted to the bottom in the figure while a part of the incident light can be randomly dispersed to the top side of the figure (the base member 2 side). Light that is incident from the bottom side in the figure can also be randomly dispersed and emitted to the top side of the figure (the base member 2 side). As a result, light (external light) that is incident from the top as seen in the figure (the base member 2 side) can be emitted to the bottom side of the figure (the side where a solar cell 94 is disposed in the wristwatch 100 described below) while also effectively preventing the user from seeing through the timepiece dial 1 and seeing what is on the inside side (the bottom in the figure) of the timepiece dial 1 when looking from the outside of the timepiece dial 1 (the top in the figure). More particularly, because light is emitted (scattered) to the base member 2 side by the silicon oxide particle dispersion layer 4 in this timepiece dial 1, the timepiece dial 1 has a high luster appearance and has a feeling of extremely high quality.

By thus having a base member of primarily polycarbonate, a titanium oxide particle dispersion layer, and a silicon oxide particle dispersion layer rendered in a specific order, the timepiece dial of the present invention features excellent transmittance of electromagnetic waves (radio waves and light), outstanding durability, and an outstanding, high quality appearance. This outstanding effect is not achieved when any one of these layers is absent, however.

For example, if any one or two of the base member, titanium oxide particle dispersion layer, or silicon oxide particle dispersion layer is omitted, the timepiece dial cannot be rendered with a sufficiently outstanding appearance, and the durability of the timepiece dial will also be deficient. The timepiece dial also cannot be rendered with a sufficiently outstanding appearance and the durability of the timepiece dial will also be deficient if a layer effectively composed of only titanium oxide (a layer in which a dispersoid is not dispersed) is disposed instead of the titanium oxide particle dispersion layer, or if a layer effectively composed of only silicon oxide (a layer in which a dispersoid is not dispersed) is disposed instead of the silicon oxide particle dispersion layer.

More particularly, the silicon oxide particle dispersion layer 4 is disposed to the opposite side of the base member 2 as the side to which the titanium oxide particle dispersion layer 3 is disposed in this embodiment of the invention. This imparts a sufficiently outstanding appearance to the timepiece dial 1 while also imparting the timepiece dial 1 with particularly outstanding durability. In other words, by rendering a particle dispersion layer (titanium oxide particle dispersion layer 3 and silicon oxide particle dispersion layer 4) containing a dispersion of fine particles (titanium oxide particles 31 and silicon oxide particles 41) on opposite sides of the base member 2, outstanding durability is achieved even though the thickness of the timepiece dial 1 is relatively thin.

The silicon oxide material used to render the silicon oxide particle dispersion layer 4 is a compound of Si and O. The fine particles of this silicon oxide material generally have an excellent light scattering action. As a result, light that is incident through the base member 2 and titanium oxide particle dispersion layer 3 can be effectively scattered, and the timepiece dial 1 can be imparted with a particularly outstanding appearance.

While not specifically limited, the refractive index of the silicon oxide particles 41 is preferably 1.20-1.54, and is further preferably 1.40-1.50. This enables the silicon oxide particle dispersion layer 4 to more desirably scatter light, and can impart a particularly outstanding appearance to the timepiece dial 1.

The silicon oxide particles 41 can be composed of any silicon oxide material that is a compound of primarily Si and O. Examples of such titanium oxide materials include silicon dioxide (SiO₂) and silicon monoxide (SiO). Of these, silicon dioxide is preferable as the material of the silicon oxide particles 41. This affords sufficiently high transmittance of electromagnetic waves (radio waves and light) while also imparting the timepiece dial 1 with a particularly outstanding appearance.

In addition to silicon, the silicon oxide material can use oxides including other metals (such as plural oxides). The silicon oxide particles 41 could also have a surface process applied to particles made of primarily silicon oxide. This enables reliably preventing agglomeration of the silicon oxide particles 41 in the silicon oxide particle dispersion layer 4, for example, improves the dispersion properties of the silicon oxide particles 41, and enables imparting a particularly good appearance to the timepiece dial 1. Examples of surface processing methods that can be applied to the particles made of primarily silicon oxide include surface processing with HMDS, silane coupling agents (including agents having an amino group or other functional group), titanate coupling agents, fluorinated silane coupling agents, and silicone oil.

The average particle diameter of the silicon oxide particles 41 is preferably 10-250 nm, and further preferably 20-150 nm. If the average particle diameter of the silicon oxide particles 41 is within this range, the color of the silicon oxide particle dispersion layer 4 can be whitened and the ability to see the solar cell 94 disposed below the timepiece dial 1 can be reduced. In addition, incident light can be more effectively scattered while assuring sufficiently high transmittance of electromagnetic waves (radio waves and light), and the timepiece dial 1 can be imparted with an even more outstanding appearance.

If the average particle diameter of the titanium oxide particles 31 is D_{TO} [nm] and the average particle diameter of the silicon oxide particles 41 is D_{SO} [nm], the average particle diameters preferably satisfy the condition 3·D_{SO}/D_{TO}·10, and further preferably 4·D_{SO}/D_{TO}·8. This affords sufficiently high transmittance of electromagnetic waves (radio waves and light) while imparting the timepiece dial 1 with a particularly outstanding appearance.

The shape of the silicon oxide particles 41 is not specifically limited, and could be substantially spherical, scale shaped, needle shaped, or any other shape. The particles could also be irregularly shaped.

The content of the silicon oxide particles 41 in the silicon oxide particle dispersion layer 4 is preferably 3-35 vol %, and further preferably 7-28 vol %. If the content of the silicon oxide particles 41 is within this range, incident light can be better scattered while assuring sufficiently high transmittance of electromagnetic waves (radio waves and light), and a particularly good appearance can be imparted to the timepiece dial 1. The silicon oxide particle dispersion layer 4 can also be imparted with excellent stability (impact resistance) to external forces such as impact force, and the overall timepiece dial 1 can be imparted with excellent durability and reliability.

The dispersion medium 42 used in the silicon oxide particle dispersion layer 4 is made from a transparent material. Examples of materials that can be used for the dispersion medium 32 include various types of resins, non-alkaline glass, soda glass, crystalline glass, quartz glass, lead glass, potassium glass, borosilicate glass, and other types of glass materials, but a resin material is preferable. This assures sufficiently high transmittance of electromagnetic waves (radio waves and light), and a particularly good appearance can be imparted to the timepiece dial 1. Furthermore, using a plastic material for the dispersion medium 32 affords superior adhesion between the titanium oxide particle dispersion layer 3 and the polycarbonate base member 2 than if a different material (such as a glass material) is used for the dispersion medium 32. The titanium oxide particle dispersion layer 3 can also be imparted with excellent stability (impact resistance) to external forces such as impact force. As a result, the overall timepiece dial 1 can be imparted with excellent durability and reliability.

The dispersion medium 42 used in the silicon oxide particle dispersion layer 4 is made from a transparent material. Examples of materials that can be used for the dispersion medium 42 include various types of resins, non-alkaline glass, soda glass, crystalline glass, quartz glass, lead glass, potassium glass, borosilicate glass, and other types of glass materials, but a resin material is preferable. This assures sufficiently high transmittance of electromagnetic waves (radio waves and light), and enables imparting a particularly good appearance to the timepiece dial 1. Furthermore, using a plastic material for the dispersion medium 42 affords superior adhesion between the silicon oxide particle dispersion layer 4 and the polycarbonate base member 2 than if a different material (such as a glass material) is used for the dispersion medium 42. The silicon oxide particle dispersion layer 4 can also be imparted with excellent stability (impact resistance) to external forces such as impact force. As a result, the overall timepiece dial 1 can be imparted with excellent durability and reliability.

The materials that can be used for the dispersion medium 32 described above can also be used as the plastic material rendering the dispersion medium 42. Of these materials, a particularly good appearance can be imparted to the timepiece dial 1 if an acrylic resin is used for the dispersion medium 42.

The silicon oxide particle dispersion layer 4 can contain materials other than the above. Examples of such materials include plasticizers, oxidation inhibitors, coloring agents (including colorants, fluorescent materials, and phosphorescent materials), brighteners, and fillers. For example, if the silicon oxide particle dispersion layer 4 is made of a material including a colorant, the timepiece dial 1 can be rendered in more color variations.

The thickness of the silicon oxide particle dispersion layer 4 is not specifically limited, but is preferably 0.5-30 μm, and further preferably is 2-20 μm. If the thickness of the silicon oxide particle dispersion layer 4 is within this range, incident light can be better scattered while assuring sufficiently high transmittance of electromagnetic waves (radio waves and light), and a particularly good appearance can be imparted to the timepiece dial 1.

When used in a timepiece, the timepiece dial 1 described above can be used in any desirable orientation, but is preferably disposed so that the base member 2 is closer to the viewer than the silicon oxide particle dispersion layer 4, that is, the top as seen in the figure is disposed toward the viewer. This enables imparting the timepiece dial 1 with a particularly outstanding appearance.

When defined in the L*a*b* color space defined in JIS Z 8729, the color of the surface of the base member 2 on the opposite side as the side to which the silicon oxide particle dispersion layer 4 is disposed in this timepiece dial 1 preferably has an a* value of −8 to 8 and ab* value of −8 to 8, and further preferably an a* value of −4 to 4 and a b* value of −4 to 4. This results in a timepiece dial 1 with a particularly outstanding appearance.

In addition, when defined in the L*a*b* color space defined in JIS Z 8729, the color of the surface of the base member 2 on the opposite side as the side to which the silicon oxide particle dispersion layer 4 is disposed in this timepiece dial 1 preferably has an L* value of 50-85 and further preferably an L* value of 70-85. This results in a timepiece dial 1 with a high degree of whiteness and an even higher appearance of high quality.

The thickness of the timepiece dial 1 is not specifically limited but is preferably 150-700 μm, further preferably 200-600 μm, and yet further preferably 300-500 μm. If the thickness of the timepiece dial 1 is within this range, the timepiece in which the timepiece dial 1 is used can be effectively prevented from becoming thick, and the timepiece dial 1 can be rendered with excellent mechanical strength and shape stability.

Because the timepiece dial 1 has a titanium oxide particle dispersion layer 3 and a silicon oxide particle dispersion layer 4 disposed to a base member 2 as described above, variation in reflectivity at all wavelengths in the visible spectrum (380-780 nm wavelength range) can be sufficiently minimized. If variation in reflectivity at all wavelengths in the visible spectrum is thus sufficiently small, whiteness is high and an outstanding high quality appearance can be achieved. In other words, the foregoing effect can be achieved if the difference A-B is sufficiently low across the visible spectrum (380-780 nm wavelength range) where A [%] is the reflectivity at the wavelength where reflectivity is greatest and B [%] is the reflectivity at the wavelength where reflectivity is lowest. While the difference A-B is thus preferably sufficiently small, the difference is more specifically less than 25%, more preferably less than 20%, and yet further preferably less than 10%. This makes the foregoing effect even more pronounced.

As described above, the timepiece dial 1 features an outstanding appearance and outstanding transmittance of electromagnetic waves. As a result, the timepiece dial 1 can be used in radio-controlled timepieces, solar-powered timepieces (timepieces having an internal solar cell), and solar-powered radio-controlled timepieces.

Furthermore, because the timepiece dial 1 has outstanding durability, the timepiece dial 1 can also be used in portable timepieces (such as a wristwatch).

### <Timepiece Dial (Second Embodiment)>

A second embodiment of a timepiece dial according to the present invention is described next. The following description focuses on the differences between this and the foregoing embodiment (first embodiment), and further description of like parts is omitted.

FIG. 2 is a section view of a second embodiment of a timepiece dial according to the present invention.

As shown in FIG. 2, a timepiece dial 1 according to this embodiment of the invention has a base member (substrate) 2 made of primarily polycarbonate, a titanium oxide particle dispersion layer 3 having titanium oxide particles 31 made from titanium oxide dispersed in a dispersion medium 32, and a silicon oxide particle dispersion layer 4 having silicon oxide particles 41 dispersed in a dispersion medium 42, and is arranged with the titanium oxide particle dispersion layer 3 disposed between the base member 2 and the silicon oxide particle dispersion layer 4. In other words, the titanium oxide particle dispersion layer 3 and the silicon oxide particle dispersion layer 4 are disposed in contact with each other on the opposite side of the base member 2 as the side facing the viewer. This arrangement results in a timepiece dial 1 with a particularly outstanding appearance.

If the refractive index of the titanium oxide particles 31 is n₃ and the refractive index of the silicon oxide particles 41 is n₄, the difference n₃-n₄ between the refractive indices of the titanium oxide particles 31 and the silicon oxide particles 41 in this timepiece dial 1 is preferably 0.91-1.65, and further preferably is 1.05-1.40. This enables more desirably scattering light at the silicon oxide particle dispersion layer 4, and can impart the timepiece dial 1 with a particularly outstanding appearance. A timepiece dial 1 having the titanium oxide particle dispersion layer 3 and silicon oxide particle dispersion layer 4 containing titanium oxide particles 31 and silicon oxide particles 41 satisfying the foregoing condition disposed in contact with each other can use external light incident to the timepiece dial 1 more efficiently. More specifically, when this timepiece dial 1 is used in the wristwatch 100 described below, light rays that are incident to the timepiece dial 1 at an angle and do not contribute sufficiently to charging the solar cell 94 are desirably reflected at the interface between the base member 2 and titanium oxide particle dispersion layer 3. In addition, the difference between the refractive indices of the titanium oxide particles 31 and the dispersion medium 32 causes incident light to be desirably reflected and refracted at the numerous interfaces between the dispersion medium 32 and the many titanium oxide particles 31 dispersed therein. The timepiece dial 1 can therefore feature both excellent optical transparency and an outstanding appearance.

### <Timepiece Dial (Third Embodiment)>

A third embodiment of a timepiece dial according to the present invention is described next. The following description focuses on the differences between this and the foregoing first embodiment or second embodiment, and further description of like parts is omitted.

FIG. 4 is a section view of this third embodiment of a timepiece dial according to the present invention.

As shown in FIG. 4, the timepiece dial 1 in this embodiment of the invention is identical to the second embodiment except for additionally having a reflective film 5 in which openings 6 are formed disposed on the opposite side of the primarily polycarbonate base member 2 as the surface to which the titanium oxide particle dispersion layer 3 is disposed.

A function of this reflective film 5 is to reflect outside light. Because part of the light incident from the outside of the timepiece dial 1 (the top side as seen in the figure) is reflected by the surface of this reflective film 5, the timepiece dial 1 thus arranged features even greater luster and a higher sense of quality. In addition, light that passes through the openings 6 in the reflective film 5 and is incident to the base member 2 is desirably reflected and refracted at the interface between the base member 2 and the titanium oxide particle dispersion layer 3, the numerous interfaces of the numerous dispersed titanium oxide particles 31, and the interface between the titanium oxide particle dispersion layer 3 and the silicon oxide particle dispersion layer 4 as described above. Therefore, the timepiece dial 1 according to this embodiment of the invention achieves the effect (outstanding optical transparency balanced with an outstanding appearance) of the timepiece dial according to the foregoing second embodiment, while also providing even greater luster and an appearance with an outstanding feeling of high quality.

Furthermore, at the interface between the base member 2 and the titanium oxide particle dispersion layer 3, the numerous interfaces between the dispersion medium 32 and the numerous titanium oxide particles 31 dispersed therein, and the interface between the titanium oxide particle dispersion layer 3 and the silicon oxide particle dispersion layer 4, part of the light (reflected light) reflected (scattered) at the reflective film 5 side is emitted to the outside of the timepiece dial 1 (the top side in the figure) through the openings 6, and part of the reflected light is reflected at the surface of the reflective film 5 opposing the base member 2 to the titanium oxide particle dispersion layer 3 side and emitted to the bottom side of the timepiece dial 1 in the figure. As a result, the timepiece dial 1 offers even greater optical transparency. By thus disposing a reflective film 5 to the timepiece dial 1, part of the light incident to the timepiece dial 1 from the outside is reflected as light with even greater brightness. As a result, a sufficiently outstanding appearance is achieved even if relatively little light is reflected from the base member 2 side to the outside of the timepiece dial 1 through the openings 6.

Furthermore, in general, a timepiece dials that have an opening for use in a solar-powered timepiece, for example, take incident light from the outside through the opening into the timepiece dial (through the timepiece dial) and must render the opening inconspicuous in order to prevent degrading the appearance of the timepiece dial. The timepiece dial 1 according to this embodiment of the invention has a titanium oxide particle dispersion layer 3 and a silicon oxide particle dispersion layer 4 disposed to the opposite side of the base member 2 as the surface to which the reflective film 5 is disposed. As a result, the timepiece dial 1 has sufficiently outstanding optical transparency while reliably preventing the openings 6 from being conspicuous to the viewer, and thus has an outstanding appearance.

The reflective film 5 disposed to the timepiece dial 1 in this embodiment of the invention is described next.

[Reflective Film]

A reflective film 5 with the ability to reflect outside light is disposed to the surface of the base member 2 on the opposite side as the titanium oxide particle dispersion layer 3.

The reflective film 5 can be made from any material that has the ability to reflect light, but is preferably made from a metallic material. This enables imparting the timepiece dial 1 with a particularly outstanding appearance (high quality). The reflective film 5 is described below referring particularly to a metallic coating that is made primarily from a metal material.

Various kinds of metals (including alloys) can be used as the metallic material rendering the reflective film (metallic coating) 5, including, for example, Fe, Cu, Zn, Ni, Mg, Cr, Mn, Mo, Nb, Al, V, Zr, Sn, Au, Pd, Pt, Hf, Ag, Co, In, W, Ti, Rh, and alloys containing at least one of these metals. Of these, if the reflective film 5 is made from a material (including an alloy) containing at least one selected from a group composed of Ag and Al, reflection by the reflective film 5 as described above can be achieved even more effectively, and the appearance of the timepiece dial 1 can be rendered with even brighter colors. Furthermore, if the reflective film 5 is made using the foregoing materials, outstanding adhesion can be achieved between the reflective film 5 and the base member 2. The reflective film 5 can also have a uniform composition throughout, or not. For example, the constituent components (composition) of the reflective film 5 could vary gradually through the thickness direction (a gradient material). The reflective film 5 could alternatively be a laminate having a plurality of layers. If the reflective film 5 is a laminate, it can include a layer composed of a material that effectively contains a metal material. More specifically, the reflective film 5 could have a layer composed of a metal oxide material, for example, between two layers made of a metallic material.

The thickness of the reflective film 5 is not specifically limited, but is preferably 0.005-2.5 μm, further preferably is 0.007-0.9 μm, and yet further preferably is 0.01-0.5 μm. If the average thickness of the reflective film 5 is within this range, an increase in the internal stress of the reflective film 5 can be sufficiently prevented, the function of the reflective film 5 described above can be more effectively achieved, and the timepiece dial 1 can be imparted with a particularly outstanding appearance. Particularly outstanding adhesion can also be achieved between the reflective film 5 and the base member 2. Depending on the composition of the reflective film 5, however, if the average thickness of the reflective film 5 is less than the foregoing lower limit, it be difficult to achieve the foregoing function of the reflective film 5, and it may be difficult to achieve a sufficiently outstanding appearance in the timepiece dial 1. Furthermore, depending on the composition of the reflective film 5, it may also be difficult to sufficiently improve adhesion between the reflective film 5 and the base member 2. On the other hand, if the average thickness of the reflective film 5 exceeds the foregoing upper limit, there is a pronounced tendency to reduce the electromagnetic wave (radio wave) transmittance of the timepiece dial 1, and using the timepiece dial 1 in a radio-controlled timepiece will be difficult. Furthermore, if the average thickness of the reflective film 5 exceeds the foregoing upper limit, variation in the thickness at different part of the reflective film 5 tends to increase. Furthermore, if the average thickness of the reflective film 5 is particularly great, the internal stress of the reflective film 5 increases and cracks, for example, occur easily.

The reflective film 5 also has openings 6 disposed in a prescribed pattern. By thus rendering the openings 6, part of the light incident to the timepiece dial 1 can be guided to the base member 2, and as a result can be emitted from the side opposite that to which the light was incident. More specifically, the timepiece dial 1 can pass part of the light incident thereto. The optical transmittance of the overall timepiece dial 1 is thus assured by providing the openings 6, and the presence of the openings 6 is obscured to the viewer because the reflective film 5 reflects part of the light incident thereto from the outside side of the timepiece dial 1 back to the outside. This arrangement thus makes it possible to achieve both particularly outstanding light transmittance and an outstanding appearance.

While the method of forming the openings 6 is not specifically limited, etching, for example, is preferred. Forming the openings 6 by means of etching enables rendering desirable openings 6 as described below.

The aperture ratio, which is the area ratio of the openings 6 to the reflective film 5 when the base member 2 (timepiece dial 1) is seen in plan view, is preferably 15-75%, further preferably is 25-70%, and yet further preferably is 29-65%. If the aperture ratio of the reflective film 5 is within this range, the timepiece dial 1 can be imparted with a particularly outstanding appearance (high quality) while achieving sufficiently outstanding transmittance of light (outside light). If the aperture ratio of the reflective film 5 is less than the foregoing lower limit, achieving sufficiently outstanding optical transmittance in the timepiece dial 1 overall may be difficult. On the other hand, if the aperture ratio of the reflective film 5 exceeds the foregoing upper limit, achieving a sufficiently outstanding appearance in the timepiece dial 1 may be difficult depending upon the thickness of the titanium oxide particle dispersion layer 3 and the silicon oxide particle dispersion layer 4, and the content of the titanium oxide particles 31 and silicon oxide particles 41 in the respective layers.

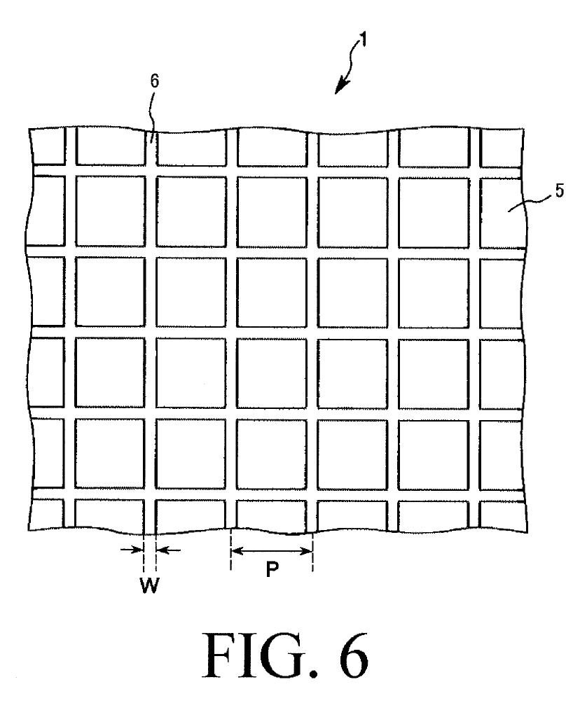

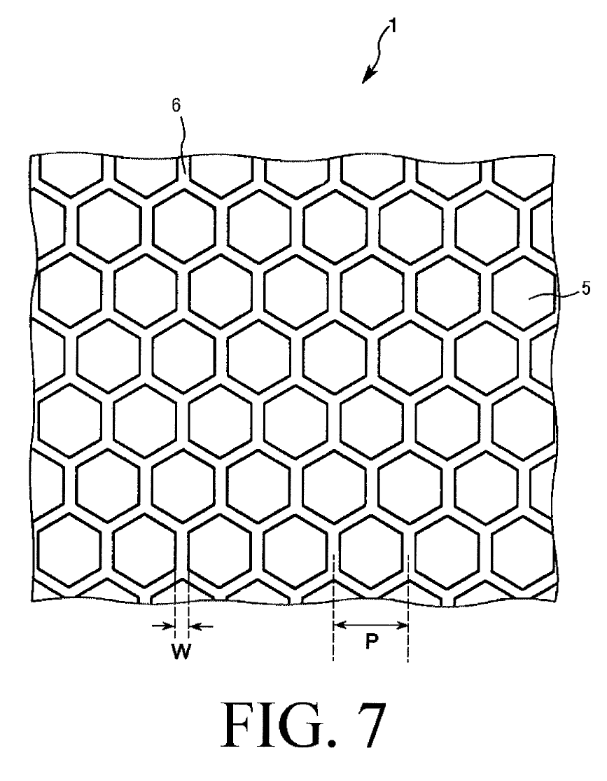

The openings 6 can have any desirable shape. The shape of the openings 6 when the base member 2 (timepiece dial 1) is seen in plan view can be substantially round, substantially elliptical, substantially polygonal, or slit shapes, for example. When the base member 2 (timepiece dial 1) is seen in plan view, the openings 6 can be rendered surrounding a plurality of island-shaped regions of the reflective film 5 (parts of the actual reflective film 5) as shown in FIG. 6 and FIG. 7. This can render the presence of the openings 6 even more inconspicuous in the appearance of the timepiece dial 1, and affords outstanding productivity when manufacturing the timepiece dial 1.

The width of the openings 6 (the diameter when the openings 6 are substantially circular), which is denoted W in the figures, is preferably 10-200 μm, further preferably 30-170 μm, and yet further preferably 35-150 μm. If the width W of the openings 6 is within the foregoing range, the timepiece dial 1 can be rendered with a particularly outstanding appearance (aesthetic) while achieving sufficiently high optical transmittance in the timepiece dial 1. If the width W of the openings 6 is less than the foregoing lower limit, it may be difficult to achieve sufficiently high overall light transmittance in the timepiece dial 1 depending on other factors such as the aperture ratio of the openings 6. On the other hand, if the width W of the openings 6 is greater than the foregoing upper limit, achieving a sufficiently outstanding appearance in the timepiece dial 1 may be difficult.

The pitch of the openings 6, denoted P1 in the figure, is preferably 70-400 μm, further preferably 80-350 μm, and yet further preferably 90-300 μm. If the pitch P of the openings 6 is within the foregoing range, the timepiece dial 1 can be rendered with a particularly outstanding appearance (aesthetic) while achieving sufficiently high optical transmittance in the timepiece dial 1. The pitch of the openings 6 indicates the center-center distance between one opening 6 and an adjacent opening 6, and indicates the center-center distance between the closest openings 6 if there are plural adjacent openings 6.

### <Timepiece Dial (Fourth Embodiment)>

A fourth embodiment of a timepiece dial according to the present invention is described next. The following description focuses on the differences between this and the foregoing first to third embodiments, and further description of like parts is omitted.

FIG. 5 is a section view of this fourth embodiment of a timepiece dial according to the present invention.

As shown in FIG. 5, the timepiece dial 1 in this embodiment of the invention has a base member (substrate) 2 made of primarily polycarbonate, a titanium oxide particle dispersion layer 3 having titanium oxide particles 31 made from titanium oxide dispersed in a dispersion medium 32, and a silicon oxide particle dispersion layer 4 having silicon oxide particles 41 dispersed in a dispersion medium 42, and is arranged with the silicon oxide particle dispersion layer 4 disposed between the base member 2 and the titanium oxide particle dispersion layer 3. In other words, the titanium oxide particle dispersion layer 3 and the silicon oxide particle dispersion layer 4 are disposed in this order to the viewer-side surface of the base member 2. On the surface (second surface 22) on the opposite side (bottom as seen in the figure) as the surface (first surface 21) of the base member 2 opposing the silicon oxide particle dispersion layer 4, the base member 2 also has minute pits and lands 221 with the ability to reflect and scatter light incident from the outside surface side of the base member 2 (the bottom as seen in the figure).

By desirably reflecting (scattering) and refracting light at the outside surface of the titanium oxide particle dispersion layer 3 (the surface of the titanium oxide particle dispersion layer 3 on the opposite side as the surface opposing the silicon oxide particle dispersion layer 4), the numerous interfaces between the dispersion medium 32 and the numerous dispersed titanium oxide particles 31, the interface between the titanium oxide particle dispersion layer 3 and the silicon oxide particle dispersion layer 4, and the interface between the silicon oxide particles 41 and silicon oxide particle dispersion layer 4 and the base member 2 in the timepiece dial 1 thus comprised, the optical transmittance and appearance of the timepiece dial 1 are both outstanding.

Furthermore, the timepiece dial 1 has pits and lands 221 with the ability to reflect and refract light incident from the outside surface side of the base member 2 disposed to the second surface 22 of the base member 2.

When the timepiece dial 1 is used in a timepiece, a solar battery, movement, and other components are located behind the timepiece dial 1 (on the opposite side as the side facing the viewer). As a result, light passing from the first surface 21 side through the base member 2 is emitted to the members located behind the timepiece dial 1, and part of the light reflected by said members passes again from the base member 2 side into the base member 2. Light that has once passed through the timepiece dial and then re-enters from the opposite side and is again emitted toward the viewer could reduce the aesthetic appeal (appearance), but the timepiece dial 1 according to the invention has pits and lands 221 as described above rendered on the second surface 22 of the base member 2. As a result, when light that is once emitted from the second surface 22 side of the base member 2 is then emitted (reflected) toward the second surface side of the base member 2, this light (also referred to “emitted light from the back” below) is reflected and scattered by the pits and lands 221, the emitted light from the back is thereby prevented from being seen directly by the viewer, and the appearance of the timepiece dial 1 can be further improved. In addition, part of the emitted light from the back is reflected by the pits and lands 221 back to the back side. As a result, in a timepiece that has this timepiece dial 1 and a solar battery, for example, light that is once reflected by the surface of the solar battery can be emitted again toward the solar battery by this effect of the pits and lands 221. As a result, the utilization efficiency of light by the solar battery (nominal utilization efficiency) is particularly great. In other words, the timepiece dial 1 features an excellent appearance and can be desirably used in a timepiece (a solar-powered timepiece) having a solar cell without standing light utilization efficiency.

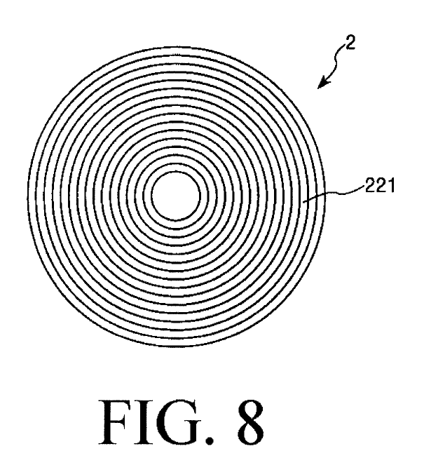

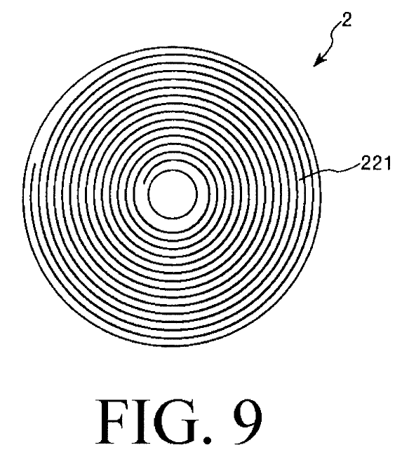

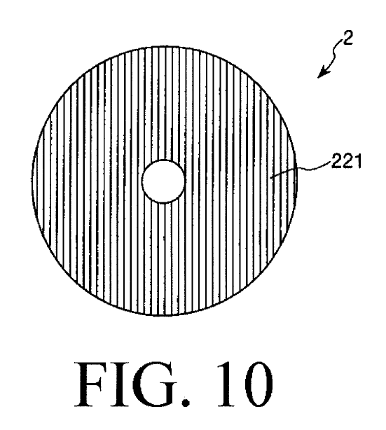

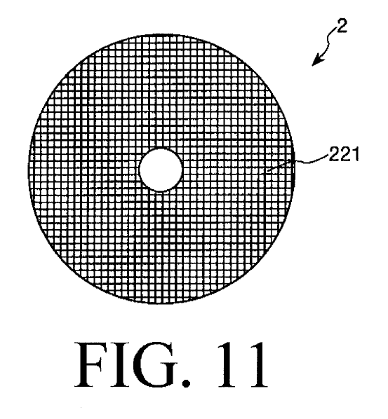

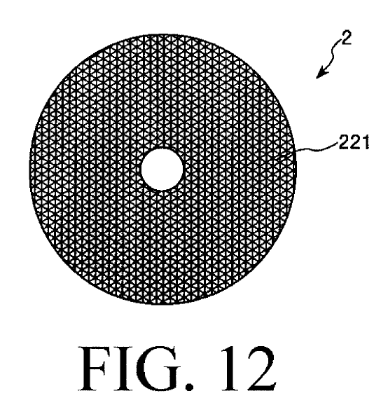

The pits and lands 221 can be disposed in any way, but are preferably arranged in an ordered pattern when the base member 2 is seen in plan view. This enables effectively preventing unintentional color variations indifferent parts of the timepiece dial 1 (parts seen in plan view). Possible arrangement patterns for the pits and lands 221 (patterns when see in plan view) include, for example, a pattern of numerous concentric lands and grooves (see FIG. 8), a spiral-shaped land and groove pattern (FIG. 9), a pattern of numerous lands and grooves arranged in one direction, (FIG. 10), and patterns of numerous lands and grooves arranged in two directions (FIG. 11 and FIG. 12).

The pitch P2 of the pits and lands 221 (particularly the pitch perpendicular to the length of the lands and grooves in the second surface 22) is not specifically limited, but is preferably 8-160 μm, further preferably 10-100 μm, and yet further preferably 12-28 μm. If the pitch P₁ between the pits and lands 221 is within the foregoing range, the timepiece dial 1 can be imparted with a particularly outstanding appearance.

The height difference H (the difference between the peak of the land portion (peak) and the bottom of the groove portion (valley)) of the pits and lands 221 is not specifically limited, but is preferably 3-90 μm, further preferably 4-55 μm, and yet further preferably 5-16 μm. If the height difference H of the pits and lands 221 is within the foregoing range, the timepiece dial 1 can be imparted with a particularly outstanding appearance while achieving sufficiently high light transmittance in the timepiece dial 1.

In the arrangement shown in the figures, the cross sectional shape of the pits and lands 221 (the shape in section perpendicular to the length of the lands and grooves) is an isosceles triangle. If the pits and lands 221 have this cross sectional shape, light that is incident from the first surface 21 side can be appropriately reflected and scattered, and the timepiece dial 1 can be rendered with both particularly high light transmittance and an outstanding appearance.

The angle (θ in the figure) of the vertex of the pits and lands 221 is not specifically limited, but is preferably 70-1000. This enables appropriately reflecting and scattering light incident from the first surface 21 side, and rendering the timepiece dial 1 with both extremely high light transmittance and a particularly outstanding appearance.

The first surface 21 side of the base member 2 is preferably actually flat (smooth). This results in a timepiece dial 1 with a particularly outstanding appearance. More specifically, the surface roughness Ra of the first surface 21 is preferably 0.001-0.6 μm, and further preferably 0.001-0.3 μm. This makes the foregoing effects particularly pronounced.

The shape and size of the base member 2 are not particularly limited, and are normally determined according to the shape and size of the base member 2 to be manufactured. Note that while the base member 2 is shown flat in the figures, the base member 2 could be curved, for example.

<Timepiece>

A timepiece according to the present invention having the foregoing timepiece dial according to the present invention is described next.

The timepiece according to the present invention has the timepiece dial of the invention as described above. As described above, the timepiece dial according to the present invention has outstanding light transmittance (electromagnetic wave transmittance) and decorativeness (appearance). As a result, the timepiece of the invention having this timepiece dial sufficiently meets the conditions required for a solar-powered timepiece or a radio-controlled timepiece. Note that other than the timepiece dial (which is the timepiece dial of the invention), parts known from the literature can be used for the parts of the timepiece according to the present invention, and just one example of the arrangement of a timepiece according to the present invention is described below.

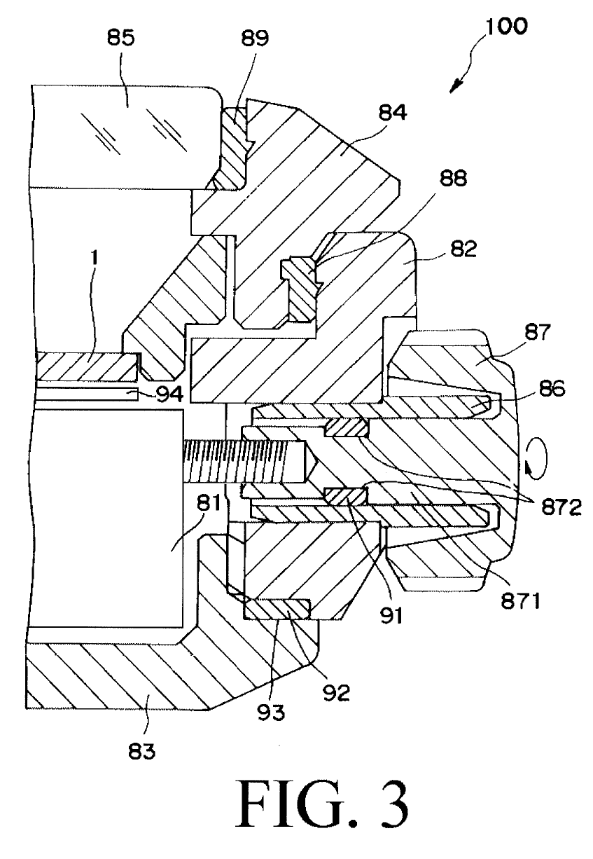

FIG. 3 is a section view showing a preferred embodiment of a timepiece (wristwatch) according to the present invention.

As shown in FIG. 3, a wristwatch (portable timepiece) 100 according to this embodiment of the invention has a case member 82, a back cover 83, a bezel 84, and a glass crystal 85. The timepiece dial 1 of the invention as described above, a solar cell 94, and a movement 81 are housed inside the case member 82, and hands not shown are also provided.

The glass crystal is normally made from transparent glass or sapphire with high transparency. This sufficiently exhibits the aesthetic appeal of the timepiece dial 1 of the invention, and enables a sufficient amount of light to be incident to the solar cell 94.

The movement 81 drives the hands using electromotive power from the solar cell 94.

Though not shown in FIG. 3, the movement 81 includes, for example, an electric double layer capacitor or lithium-ion secondary battery for storing power from the solar cell 94, a crystal oscillator as a reference time source, a semiconductor integrated circuit for producing a drive pulse to drive the timepiece based on the oscillation frequency of the crystal oscillator, a stepping motor for driving the hands every second based on this drive pulse, and a wheel train for transmitting movement of the stepping motor to the hands.

The movement 81 also has an antenna not shown for receiving radio signals. The movement 81 also has a function for adjusting the time, for example, based on the received signals.

The solar cell 94 has a function for converting light energy to electrical energy. The electrical energy converted by the solar cell 94 is used to drive the movement, for example.

The solar cell 94 has a pin structure containing p-type impurities and n-type impurities selectively introduced to a non-single crystal silicon thin film, and an i-type non-single crystal silicon thin film disposed between a p-type non-single crystal silicon thin film and an n-type non-single crystal silicon thin film.

A stem pipe 86 is fit and fastened to the case member 82, and the stem 871 of the crown 87 is inserted freely rotatably inside the stem pipe 86.

The case member 82 and bezel 84 are fastened by plastic packing 88, and the bezel 84 and glass crystal are secured by plastic packing 89.

The back cover 83 is fit (or threaded) to the case member 82, and a rubber O-ring (back cover packing) 92 is compressed and inserted to the connection (seal) 93 there between. This makes the seal 93 watertight and imparts water resistance.

A groove 872 is formed around the outside of the middle part of the stem 871 of the crown 87, and an O-ring (crown packing) 91 is fit into this groove 872. The O-ring 91 fits tight to the inside surface of the stem pipe 86, and is compressed between this inside surface and the inside surface of the groove 872. This forms a watertight seal between the crown 87 and the stem pipe 86, and achieves a water resistance function. When the crown 87 is wound, the O-ring 91 turns with the stem 871 and slides circumferentially along the inside surface of the stem pipe 86.

This type of portable timepiece (wristwatch) requires particularly outstanding durability (such as impact resistance) compared with other types of timepieces, and is an excellent application for the present invention, which provides both an outstanding appearance and outstanding durability.

A wristwatch (portable timepiece) is used by way of example as a solar-powered radio-controlled timepiece, which is one example of a timepiece, but the invention can be used in the same way in other types of timepieces, including portable timepieces other than wristwatches, table clocks, and wall clocks. The invention also applies to all types of timepieces, including solar-powered timepieces other than solar-powered radio-controlled timepieces, and radio-controlled timepieces other than solar-powered radio-controlled timepieces.

Preferred embodiments of the present invention are described above, but the invention is not limited to the foregoing.

For example, various parts in the timepiece dial and timepiece described above according to the present invention can be replaced by other parts that achieve the same function, and other parts can also be added. For example, printed parts made by various printing methods can be included.

The timepiece dial according to the present invention can also be rendered using different combinations of the desired parts of the foregoing embodiments.

A coating (coating layer) having at least one layer can also be disposed to the surface of the timepiece dial (the surface of the titanium oxide particle dispersion layer (the surface on the opposite side as the surface facing the base member or silicon oxide particle dispersion layer), the surface of the silicon oxide particle dispersion layer (the surface on the opposite side as the surface facing the base member or titanium oxide particle dispersion layer), or the surface of the base member (the surface on the opposite side as the surface facing the titanium oxide particle dispersion layer, silicon oxide particle dispersion layer). This layer can be a layer that is removed when the timepiece dial is used, for example.

An intermediate coating of one or two or more layers can also be disposed to each of the layers of the foregoing timepiece dial (for example, between the titanium oxide particle dispersion layer and base member, between the base member and silicon oxide particle dispersion layer, between the titanium oxide particle dispersion layer and silicon oxide particle dispersion layer, between the reflective film and base member). A color layer composed of a material containing a colorant can be disposed as this intermediate layer.

### EXAMPLES

Specific examples of the present invention are described next.

### 1. Manufacturing the Timepiece Dial

### Example 1

A timepiece dial was manufactured by the method described below.

A base member having the shape of the timepiece dial was first manufactured by means of compression molding using polycarbonate, and the base member was then cut and polished as required. The resulting base member was substantially disc shaped with a 27 mm diameter and was 500 μm thick.

The base member was then washed. The base member was washed by ultrasonic cleaning in a neutral detergent for 10 min, washed in water for 10 sec, and washed in demineralized water for 10 sec.

A titanium oxide particle dispersion layer was then formed as described below on one side of the base member after washing as described above. Titanium oxide particles made from rutile TiO₂ with a 20 nm average particle diameter were first dispersed in a mixture of acrylic resin and methyl ethyl ketone to produce a fluid dispersion. This fluid dispersion was then coated to one side of the base member. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 10 μm. The content of the particles in the titanium oxide particle dispersion layer was 25 vol %.

A silicon oxide particle dispersion layer was then formed as described below on the surface of the titanium oxide particle dispersion layer formed on the base member to acquire the timepiece dial. Silicon oxide particles made from SiO₂ with a 100 nm average particle diameter were first dispersed in a mixture of acrylic resin and methyl ethyl ketone to produce a fluid dispersion. This fluid dispersion was then coated to the surface of the titanium oxide particle dispersion layer. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 10 μm. The content of the silicon oxide particles in the silicon oxide particle dispersion layer was 25 vol %.

The thickness of the titanium oxide particle dispersion layer and the silicon oxide particle dispersion layer was measured by the microscopic cross-section testing method defined in JIS H 5821.

### Examples 2-4

Timepiece dials were manufactured in the same way as in the first example described above except that the content of the titanium oxide particles in the titanium oxide particle dispersion layer, the content of the silicon oxide particles in the silicon oxide particle dispersion layer, and the thickness of each layer were changed as shown in Table 1 by changing the amounts of each of the components in the fluid dispersion used to form the titanium oxide particle dispersion layer and the silicon oxide particle dispersion layer, and changing the thickness of the base member and the amount of the fluid dispersions that were coated to the base member to form the titanium oxide particle dispersion layer and silicon oxide particle dispersion layer.

### Examples 5-7

Timepiece dials were manufactured in the same way as in the first example described above except that the composition of the titanium oxide particle dispersion layer and the silicon oxide particle dispersion layer were changed as shown in Table 1 by changing one or two or more of the size of the particles (titanium oxide particles, silicon oxide particles) contained in the fluid dispersions used to form the titanium oxide particle dispersion layer and silicon oxide particle dispersion layer, the composition, and the type of resin.

### Example 8

A base member having the shape of the timepiece dial was first manufactured by means of compression molding using polycarbonate, and the base member was then cut and polished as required. The resulting base member was substantially disc shaped with a 27 mm diameter and was 490 μm thick.

The base member was then washed. The base member was washed by ultrasonic cleaning in a neutral detergent for 10 min, washed in water for 10 sec, and washed in demineralized water for 10 sec.

A titanium oxide particle dispersion layer was then formed as described below on one side of the base member after washing as described above. Titanium oxide particles made from rutile TiO₂ with a 20 nm average particle diameter were first dispersed in a mixture of acrylic resin and methyl ethyl ketone to produce a fluid dispersion. This fluid dispersion was then coated to one side of the base member. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 10 μm. The content of the particles in the titanium oxide particle dispersion layer was 25 vol %.

A silicon oxide particle dispersion layer was then formed as described below on the surface of the titanium oxide particle dispersion layer formed on the base member to acquire the timepiece dial. Silicon oxide particles made from SiO₂ with a 100 nm average particle diameter were first dispersed in a mixture of acrylic resin and methyl ethyl ketone to produce a fluid dispersion. This fluid dispersion was then coated to the surface of the titanium oxide particle dispersion layer. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 10 μm. The content of the silicon oxide particles in the silicon oxide particle dispersion layer was 25 vol %.

The thickness of the titanium oxide particle dispersion layer and the silicon oxide particle dispersion layer was measured by the microscopic cross-section testing method defined in JIS H 5821.

### Examples 9-11

Timepiece dials were manufactured in the same way as in the eighth example described above except that the content of the titanium oxide particles in the titanium oxide particle dispersion layer, the content of the silicon oxide particles in the silicon oxide particle dispersion layer, and the thickness of each layer were changed as shown in Table 1 by changing the amounts of each of the components in the fluid dispersion used to form the titanium oxide particle dispersion layer and the silicon oxide particle dispersion layer, and changing the thickness of the base member and the amount of the fluid dispersions that were coated to the base member to form the titanium oxide particle dispersion layer and silicon oxide particle dispersion layer.

### Examples 12 and 13

Timepiece dials were manufactured in the same way as in the eighth example described above except that the composition of the titanium oxide particle dispersion layer and the silicon oxide particle dispersion layer were changed as shown in Table 1 by changing the size of the particles (titanium oxide particles, silicon oxide particles) contained in the fluid dispersions used to form the titanium oxide particle dispersion layer and silicon oxide particle dispersion layer, or the type of resin.

### Example 14

A base member having the shape of the timepiece dial was first manufactured by means of compression molding using polycarbonate, and the base member was then cut and polished as required. The resulting base member was substantially disc shaped with a 27 mm diameter and was 490 μm thick.

The base member was then washed. The base member was washed by ultrasonic cleaning in a neutral detergent for 10 min, washed in water for 10 sec, and washed in demineralized water for 10 sec.

A titanium oxide particle dispersion layer was then formed as described below on one side of the base member after washing as described above. Titanium oxide particles made from rutile TiO₂ with a 20 nm average particle diameter were first dispersed in a mixture of acrylic resin and methyl ethyl ketone to produce a fluid dispersion. This fluid dispersion was then coated to one side of the base member. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 10 μm. The content of the particles in the titanium oxide particle dispersion layer was 25 vol %.

A silicon oxide particle dispersion layer was then formed as described below on the surface of the titanium oxide particle dispersion layer formed on the base member. Silicon oxide particles made from SiO₂ with a 100 nm average particle diameter were first dispersed in a mixture of acrylic resin and methyl ethyl ketone to produce a fluid dispersion. This fluid dispersion was then coated to the surface of the titanium oxide particle dispersion layer. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 10 μm. The content of the silicon oxide particles in the silicon oxide particle dispersion layer was 25 vol %.

A reflective film made of Ag was then formed by a sputtering method as described below (reflective film formation process) on the opposite side of the base member as the surface to which the silicon oxide particle dispersion layer and titanium oxide particle dispersion layer were formed.

The processing chamber was first vented (depressurized) to 3×10⁻³ Pa, and argon gas was then introduced at a flow rate of 35 ml/min. A reflective film of Ag was then formed using a 1400-W discharge arc for 2.0 min with an Ag target.

The average thickness of the resulting reflective film was 0.2 μm.

The surface of the reflective film was then coated with a mask formation film.

Forming the mask formation film was done using a spin coater at 3000 rpm to apply a mask formation film using a photoresist (product name: PMER) manufactured by Tokyo Ohka Kogyo Co., Ltd. on the surface of the reflective film, and then drying for 20 min at 70-100° C. The average thickness of the resulting mask formation film was approximately 10 μm.

Voids were then formed in a specific pattern in the mask formation film to form a mask with openings. The voids were formed in the mask formation film by light exposure. A super high-pressure mercury vapor lamp was used as the light source. A laser beam was also intermittently emitted while moving the light source and base member relative to each other. Emission from the light source was at 100 mJ/cm².

Openings were then formed in the parts of the reflective film not covered by the mask by etching with an etching solution.

Etching was done by showering the base member (a laminate of the base member, high refractive index material film, and reflective film) coated by the mask with the etching solution. An aqueous solution of 40-50 wt % nitric acid was used as the etching solution. The temperature of the etching solution and the etching time in this process were approximately 20° C. and approximately 5 min, respectively.

Numerous round openings passing through the reflective film were thus formed. The width (diameter) of the formed openings was 80 μm, and the pitch P between the openings was 100 μm. The ratio of the area occupied by the openings when the reflective film was seen in plan view (the area ratio of the openings) was 58%.

The mask was then removed by immersion in a demasking agent made of a sodium hydroxide solution to acquire the timepiece dial. The temperature of the demasking agent and the immersion time in the demasking agent in this process were 30-40° C. and 5-10 min, respectively. The surface roughness Ra of the exposed reflective film (the surface roughness Ra of the reflective film in the parts not including the openings) was 0.1 μm.

The thickness of the titanium oxide particle dispersion layer, the silicon oxide particle dispersion layer, the reflective film, and the mask (mask formation film) was measured by the microscopic cross-section testing method defined in JIS H 5821.

### Example 15

A base member having the shape of the timepiece dial was first manufactured by means of compression molding using polycarbonate, and the base member was then cut and polished as required. The resulting base member was substantially disc shaped with a 27 mm diameter and was 520 μm thick.

The base member was then washed. The base member was washed by ultrasonic cleaning in a neutral detergent for 10 min, washed in water for 10 sec, and washed in demineralized water for 10 sec.

A titanium oxide particle dispersion layer was then formed as described below on one side of the base member after washing as described above. Titanium oxide particles made from rutile TiO₂ with a 20 nm average particle diameter were first dispersed in a mixture of acrylic resin and methyl ethyl ketone to produce a fluid dispersion. This fluid dispersion was then coated to one side of the base member. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 0.5 μm. The content of the particles in the titanium oxide particle dispersion layer was 15 vol %.

A silicon oxide particle dispersion layer was then formed as described below on the surface of the titanium oxide particle dispersion layer formed on the base member. Silicon oxide particles made from SiO₂ with a 100 nm average particle diameter were first dispersed in a mixture of acrylic resin and methyl ethyl ketone to produce a fluid dispersion. This fluid dispersion was then coated to the surface of the titanium oxide particle dispersion layer. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 0.5 μm. The content of the silicon oxide particles in the silicon oxide particle dispersion layer was 15 vol %.

A reflective film made of Ag was then formed by a sputtering method as described below (reflective film formation process) on the opposite side of the base member as the surface to which the silicon oxide particle dispersion layer and titanium oxide particle dispersion layer were formed.

The processing chamber was first vented (depressurized) to 3×10⁻³ Pa, and argon gas was then introduced at a flow rate of 35 ml/min. A reflective film of Ag was then formed using a 1400-W discharge arc for 2.0 min with an Ag target.

The average thickness of the resulting reflective film was 0.2 μm.

The surface of the reflective film was then coated with a mask formation film.

Forming the mask formation film was done using a spin coater at 3000 rpm to apply a mask formation film using a photoresist (product name: PMER) manufactured by Tokyo Ohka Kogyo Co., Ltd. on the surface of the reflective film, and then drying for 20 min at 70-100° C. The average thickness of the resulting mask formation film was approximately 10 μm.

Voids were then formed in a specific pattern in the mask formation film to form a mask with openings. The voids were formed in the mask formation film by light exposure. A super high-pressure mercury vapor lamp was used as the light source. A laser beam was also intermittently emitted while moving the light source and base member relative to each other. Emission from the light source was at 100 mJ/cm².

Openings were then formed in the parts of the reflective film not covered by the mask by etching with an etching solution.

Etching was done by showering the base member (a laminate of the base member, high refractive index material film, and reflective film) coated by the mask with the etching solution. An aqueous solution of 40-50 wt % nitric acid was used as the etching solution. The temperature of the etching solution and the etching time in this process were approximately 20° C. and approximately 5 min, respectively.

Numerous round openings passing through the reflective film were thus formed. The width (diameter) of the formed openings was 90 μm, and the pitch P between the openings was 140 μm. The ratio of the area occupied by the openings when the reflective film was seen in plan view (the area ratio of the openings) was 29%.

The mask was then removed by immersion in a demasking agent made of a sodium hydroxide solution to acquire the timepiece dial. The temperature of the demasking agent and the immersion time in the demasking agent in this process were 30-40° C. and 5-10 min, respectively. The surface roughness Ra of the exposed reflective film (the surface roughness Ra of the reflective film in the parts not including the openings) was 0.1 μm.

The thickness of the titanium oxide particle dispersion layer, the silicon oxide particle dispersion layer, the reflective film, and the mask (mask formation film) was measured by the microscopic cross-section testing method defined in JIS H 5821.

### Example 16

A base member having the shape of a wristwatch dial was first manufactured by means of compression molding using polycarbonate, and the base member was then cut and polished as required. The resulting base member was substantially disc shaped with a 27 mm diameter and was 500 μm thick. The resulting base member had a land and groove pattern of lands and grooves formed regularly and concentrically on the entire second surface (see FIG. 8). The pitch of the lands and grooves was 25 μm. The height difference of the lands and grooves (the distance from the peak of the lands to the bottom of the grooves) was 12.5 μm. The shape of the lands and grooves in section view was an isosceles triangle, and the angle of the peak of the lands and grooves (θ in FIG. 5) was 900.

The base member was then washed. The base member was washed by degreasing in an alkali bath for 30 sec, then neutralizing for 10 sec, washing in water for 10 sec, and washing in demineralized water for 10 sec.

A silicon oxide particle dispersion layer was then formed on a first surface of the base member after washing as described above. Silicon oxide particles made from SiO₂ with a 100 nm average particle diameter were first dispersed in a mixture of acrylic resin and methyl ethyl ketone to produce a fluid dispersion. This fluid dispersion was then coated to the surface of the base member. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 10 μm. The content of the silicon oxide particles in the silicon oxide particle dispersion layer was 25 vol %.

A titanium oxide particle dispersion layer was then formed on the surface of the silicon oxide particle dispersion layer formed on the base member to acquire the timepiece dial. Titanium oxide particles made from rutile TiO₂ with a 20 nm average particle diameter were first dispersed in a mixture of acrylic resin and methyl ethyl ketone to produce a fluid dispersion. This fluid dispersion was then coated to the surface of the silicon oxide particle dispersion layer. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 10 μm. The content of the particles in the titanium oxide particle dispersion layer was 25 vol %.

The thickness of the titanium oxide particle dispersion layer and the silicon oxide particle dispersion layer was measured by the microscopic cross-section testing method defined in JIS H 5821.

### Example 17

A base member having the shape of a wristwatch dial was first manufactured by means of compression molding using polycarbonate, and the base member was then cut and polished as required. The resulting base member was substantially disc shaped with a 27 mm diameter and was 500 μm thick. The resulting base member had a land and groove pattern of lands and grooves formed regularly and concentrically on the entire second surface (see FIG. 8). The pitch of the lands and grooves was 25 μm. The height difference of the lands and grooves (the distance from the peak of the lands to the bottom of the grooves) was 12.5 μm. The shape of the lands and grooves in section view was an isosceles triangle, and the angle of the peak of the lands and grooves (θ in FIG. 5) was 900.

The base member was then washed. The base member was washed by degreasing in an alkali bath for 30 sec, then neutralizing for 10 sec, washing in water for 10 sec, and washing in demineralized water for 10 sec.

A silicon oxide particle dispersion layer was then formed on a first surface of the base member after washing as described above. Silicon oxide particles made from SiO₂ with a 100 nm average particle diameter were first dispersed in a mixture of acrylic resin and methyl ethyl ketone to produce a fluid dispersion. This fluid dispersion was then coated to the first surface of the base member. It was then left for 1 min at a pressure of 1.0 Pa and temperature of 30° C. to remove the methyl ethyl ketone and thereby form a silicon oxide particle dispersion layer having silicon oxide particles dispersed in a solid acrylic resin. The thickness of the silicon oxide particle dispersion layer thus formed was 0.5 μm. The content of the silicon oxide particles in the silicon oxide particle dispersion layer was 25 vol %.

A titanium oxide particle dispersion layer was then formed on the surface of the silicon oxide particle dispersion layer formed on the base member to acquire the timepiece dial. Titanium oxide particles made from rutile TiO₂ with a 20 nm average particle diameter were first dispersed in a mixture of acrylic resin and methyl ethyl ketone to produce a fluid dispersion. This fluid dispersion was then coated to the surface of the silicon oxide particle dispersion layer. It was then left for 1 min at a pressure of 1.0 Pa and temperature of 30° C. to remove the methyl ethyl ketone and thereby form a titanium oxide particle dispersion layer having titanium oxide particles dispersed in a solid acrylic resin. The thickness of the titanium oxide particle dispersion layer thus formed was 0.5 μm. The content of the particles in the titanium oxide particle dispersion layer was 25 vol %.

The thickness of the titanium oxide particle dispersion layer and the silicon oxide particle dispersion layer was measured by the microscopic cross-section testing method defined in JIS H 5821.

(Comparison Sample 1)

A timepiece dial was manufactured by the same method described in example 1 above except that the process forming the titanium oxide particle dispersion layer was omitted.

(Comparison Sample 2)

A timepiece dial was manufactured by the same method as comparison sample 1 above except that the thickness of the silicon oxide particle dispersion layer was changed as shown in Table 1 by changing the coating volume of the fluid dispersion used to form the silicon oxide particle dispersion layer.

(Comparison Sample 3)

A timepiece dial was manufactured by the same method described in example 1 above except that the process forming the silicon oxide particle dispersion layer was omitted.

(Comparison Sample 4)

A timepiece dial was manufactured by the same method as comparison sample 3 above except that the thickness of the titanium oxide particle dispersion layer was changed as shown in Table 1 by changing the coating volume of the fluid dispersion used to form the titanium oxide particle dispersion layer.

(Comparison Sample 5)

A timepiece dial was manufactured by the same method described in example 1 above except that a titanium oxide layer composed of only rutile TiO₂ was formed by a vapor phase film formation method instead of a titanium oxide particle dispersion layer.

The titanium oxide layer was formed as described below.

A prewashed base member was first placed in a vacuum deposition chamber, and the chamber was then preheated while venting (depressurizing) the vacuum deposition chamber to 1.3×10⁻⁴ Pa.

A laser beam was then emitted to a thin film made of at least 99% pure TiO₂ as the vapor source for 2 min to form a titanium oxide film of at least 99 wt % TiO₂. The thickness of the resulting titanium oxide layer was 10 μm.

(Comparison Sample 6)

A timepiece dial was manufactured by the same method described in example 1 above except that a silicon oxide layer composed of only SiO₂ was formed by a vapor phase film formation method instead of a silicon oxide particle dispersion layer.

The silicon oxide layer was formed as described below.

A prewashed base member was first placed in a vacuum deposition chamber, and the chamber was then preheated while venting (depressurizing) the vacuum deposition chamber to 1.3×10⁻⁴ Pa.

A laser beam was then emitted to a thin film made of at least 99% pure SiO₂ as the vapor source for 2 min to form a silicon oxide film of at least 99 wt % SiO₂. The thickness of the resulting silicon oxide layer was 10 μm.

(Comparison Sample 7)

A timepiece dial was manufactured by the same method described in example 1 above except that a base member made from acrylonitrile-butadiene-styrene copolymer (ABS resin) was used instead of a base member made of polycarbonate.

The arrangements of the foregoing examples and comparison samples are compiled in Table 1 and Table 2. Note that in Table 1 and Table 2 polycarbonate (refractive index: 1.58) is denoted PC, ABS resin (refractive index: 1.52) is denoted ABS, acrylic resin (refractive index: 1.49) is denoted PMMA, and polyvinyl acetate resin (refractive index: 1.46) is denoted PVAc. In addition, in the columns in Table 1 and Table 2 showing the lamination sequence of each timepiece dial, TiO, denotes a titanium oxide particle dispersion layer and a titanium oxide layer, and SiOₓ denotes a silicon oxide particle dispersion layer and a silicon oxide layer. Furthermore, in Table 1, the composition of the titanium oxide layer in comparison sample 5 is shown in the titanium oxide particle dispersion layer column, and the composition of the silicon oxide layer in comparison sample 6 is shown in the silicon oxide particle dispersion layer column.

TABLE 2

| | Base member | | | | | | | | | | |
|---|---|---|---|---|---|---|---|---|---|---|---|
| | | | Pits and lands | | | TiOₓ particle dispersion layer | | | | SiOₓ particle | |
| | | | Pitch | Height | Vertex | | TiOₓ particles | | Dispersion | dispersion layer | |
| | | Thickness | P2 | H | angle | Thickness | | Refractive | medium | Thickness | SiOₓ particles |
| | Material | [μm] | [μm] | [μm] | θ[•] | [μm] | Material | Index | Material | [μm] | Material |
| Example | PC | 490 | — | — | — | 10 | TiO₂ | 2.71 | PMMA | 10 | SiO₂ |
| 14 | | | | | | | (rutile) | | | | |
| Example | PC | 520 | — | — | — | 0.5 | TiO₂ | 2.71 | PMMA | 0.5 | SiO₂ |
| 15 | | | | | | | (rutile) | | | | |
| Example | PC | 500 | 25 | 12.5 | 90 | 10 | TiO₂ | 2.71 | PMMA | 10 | SiO₂ |
| 16 | | | | | | | (rutile) | | | | |
| Example | PC | 500 | 25 | 12.5 | 90 | 0.5 | TiO₂ | 2.71 | PMMA | 0.5 | SiO₂ |
| 17 | | | | | | | (rutile) | | | | |

| | SiOₓ particle | | | | | | | |
|---|---|---|---|---|---|---|---|---|
| | dispersion layer | | Reflective film | | | | | Layer |
| | SiOₓ | | | | Openings | | | sequence |
| | particles | Dispersion | | | Width | Pitch | Area | (from |
| | Refractive | medium | | Thickness | W | P1 | ratio | viewer |
| | Index | Material | Material | [μm] | [μm] | [μm] | S (%) | side) |
| Example | 1.46 | PMMA | Ag | 0.2 | 80 | 100 | 58 | Ag |
| 14 | | | | | | | | (reflective |
| | | | | | | | | film)/base |
| | | | | | | | | member/TiO_{X}/SiO_{X} |
| Example | 1.46 | PMMA | Ag | 0.2 | 90 | 140 | 29 | Ag |
| 15 | | | | | | | | (reflective |
| | | | | | | | | film)/base |
| | | | | | | | | member/ |
| | | | | | | | | TiO_{X}/SiO_{X} |
| Example | 1.46 | PMMA | — | — | — | — | — | TiO_{X}/SiO_{X}/ |
| 16 | | | | | | | | base |
| | | | | | | | | member |
| Example | 1.46 | PMMA | — | — | — | — | — | TiO_{X}/SiO_{X}/ |
| 17 | | | | | | | | base |
| | | | | | | | | member |

### 2. Visual Evaluation of Appearance

The appearance of each of the timepiece dials manufactured according to examples and comparison samples described above was visually inspected from the side on which the metal oxide layer was formed, and the appearance was graded using the six levels described below.

A: has luster and an particularly outstanding appearance

B: has an outstanding appearance

C: has a good appearance

D: has a slightly deficient appearance

E: has a poor appearance

F: has an extremely poor appearance

### 3. Appearance Evaluation Using a Spectrophotometer

The color (a*b*) of the surface on which the metal oxide layer was formed was measured for each of the timepiece dials manufactured as described in the above examples and comparison samples using a spectrophotometer (Minolta, CM-2022), and the color was graded in five levels as described below.

Extremely good (A): a* in the range −4 to 4 and b* in the range −4 to 4 in the L*a*b* color space defined in JIS Z 8729

Good (B): a* in the range −8 to 8 and b* in the range −8 to 8 in the L*a*b* color space defined in JIS Z 8729 (except not including the range for grade A)

Acceptable (C): a* in the range −10 to 10 and b* in the range −10 to 10 in the L*a*b* color space defined in JIS Z 8729 (except not including the ranges for grades A and B)

Slightly poor (D): a* in the range −15 to 15 and b* in the range −13 to 13 in the L*a*b* color space defined in JIS Z 8729 (except not including the ranges for grades A, B, and C)

Poor (E): a* outside the range −15 to 15 and b* outside the range −13 to 13 in the L*a*b* color space defined in JIS Z 8729

The light source for the spectrophotometer was a D₆₅ light source defined in JIS Z 8720, and measurements were taken at a viewing angle of 2°.

The value of L* in the L*a*b* color space defined in JIS Z 8729 was also measured and graded in the following five levels.

Extremely good (A): L* in the range 75·L*·85 in the L*a*b* color space defined in JIS Z 8729

Good (B): L* in the range 65·L*<75 in the L*a*b* color space defined in JIS Z 8729

Acceptable (C): L* in the range 50·L*<65 in the L*a*b* color space defined in JIS Z 8729

Slightly poor (D): L* in the range 45·L*<50 in the L*a*b* color space defined in JIS Z 8729

Poor (E): L* in the range L*<45 in the L*a*b* color space defined in JIS Z 8729

### 4. Variation in Reflectivity in the Visible Spectrum

The reflectivity at wavelengths in the visible spectrum (380-780 nm wavelength range) of the surface on which the metal oxide layer was formed was measured for each of the timepiece dials manufactured as described in the above examples and comparison samples. Based on these results, the difference A-B, where A (%) is the reflectivity at the wavelength where reflectivity is greatest and B (%) is the reflectivity at the wavelength where reflectivity is lowest in the visible spectrum (380-780 nm wavelength range), was obtained and graded in five levels as described below. The smaller the difference A-B, the smaller the variation in reflectivity in the visible spectrum. Note that reflectivity was measured with a solar cell disposed behind the timepiece dial.

Extremely good (A): A-B is less than 8%

Good (B): A-B is greater than or equal to 8% and less than 18%

Acceptable (C): A-B is greater than or equal to 18% and less than 23%

Slightly poor (D): A-B is greater than or equal to 23% and less than 28%

Poor (E): A-B is greater than or equal to 28%

### 5. Optical Transmittance of the Timepiece Dial

The optical transmittance of each of the timepiece dials manufactured as described in the above examples and comparison samples was evaluated by the method described below.

First, the solar cell and the timepiece dial were placed in a darkroom. The photoreception surface of the solar cell alone was then exposed to light from a fluorescent light (light source) located a prescribed distance away. The output current produced by the solar cell was measured as A (mA). After disposing the timepiece dial over the photoreception surface of the solar cell, light was again emitted in the same way from a fluorescent light (light source) located a prescribed distance away. The output current produced by the solar cell at this time was measured as B (mA). The optical transmittance of the timepiece dial was then calculated as (B/A)×100 and ranked in four levels as described below. The higher the optical transmittance, the better the optical transmittance of the timepiece dial. The timepiece dial was disposed with the surface of the base member on which the metal oxide was formed facing the fluorescent light (light source).

Extremely good (A): greater than or equal to 25%

Good (B): greater than or equal to 20% and less than 25%

Slightly poor (C): greater than or equal to 15% and less than 25%

Poor (D): less than 15%

A wristwatch as shown in FIG. 3 was then manufactured using the timepiece dial manufactured as described in the above examples and comparison samples. The manufactured wristwatches were then placed in a darkroom. Light was then emitted from fluorescent light (light source) located a prescribed distance away from the surface on the dial side of the wristwatch (the crystal side). The emission strength of the light was then varied at a constant rate so that the emission strength of the light gradually increased. Results showed that the movement was driven even at relatively low emission strength levels by all of the wristwatches according to the present invention and the wristwatches according to the comparison samples.

### 6. Radio Frequency Transmittance

The radio frequency transmittance of each of the timepiece dials manufactured as described in the above examples and comparison samples was evaluated by the method described below.

A timepiece case and an internal wrist watch module (movement) having an antenna for receiving radio signals were prepared.

The internal wristwatch module (movement) and the timepiece dial were then assembled inside the timepiece case, and the signal reception sensitivity of the assembly was then measured.

Referenced to the signal reception sensitivity when the timepiece dial was not present, the drop (dB) in reception sensitivity after the timepiece dial was included was graded in four levels as described below. The smaller the drop in the signal reception sensitivity, the better the radio frequency transmittance of the timepiece dial. The timepiece dial was disposed with the surface of the base member on which the metal oxide was formed facing the fluorescent light (light source).

Extremely good (A): no observable drop in sensitivity (less than or equal to the detection limit)

Good (B): drop in sensitivity of less than 0.7 dB

Slightly poor (C): drop in sensitivity greater than or equal to 0.7 dB and less than 1.0 dB

Poor (D): drop in sensitivity of greater than or equal to 1.0 dB

### 7. Timepiece Dial Durability

The durability of the timepiece dials manufactured as described in the above examples and comparison samples was evaluated by the two methods described below.

### 7-1 Bending Test

Each timepiece dial was bent at the center of the timepiece dial 30° around a steel rod 4 mm in diameter, the appearance of the timepiece dial was then visually inspected, and the appearance was graded in four levels as described below. Bending was in both compression and elongation directions.

A: absolutely no lifting or separation of the metal oxide layer or particle dispersion layer observed

B: substantially no lifting of the metal oxide layer or particle dispersion layer observed

C: obvious lifting of the metal oxide layer or particle dispersion layer observed

D: obvious cracking and separation of the metal oxide layer or particle dispersion layer observed

### 7-2 Heat Cycle Test

Each of the timepiece dials was also subjected to a heat cycle test as described below.

The timepiece dial was first left at rest for 1.5 hr in a 20° C. environment, then for 2 hr in a 60° C. environment, then for 1.5 hr in a 20° C. environment, and then for 3 hr in a −20° C. environment.

The environment was then returned to 20° C. to complete one cycle (8 hr), and this cycle was repeated three times (total 24 hr)

The appearance of the timepiece dial was then visually inspected, and the appearance was graded in four levels as described below.

A: absolutely no lifting or separation of the metal oxide layer or particle dispersion layer observed

B: substantially no lifting of the metal oxide layer or particle dispersion layer observed

C: obvious lifting of the metal oxide layer or particle dispersion layer observed

D: obvious cracking and separation of the metal oxide layer or particle dispersion layer observed

These results are shown in Table 3.

TABLE 3

| | Appearance | | | | | | | |
|---|---|---|---|---|---|---|---|---|
| | | Spectrophotometer | | Reflectivity | Optical | RF | Durability | |
| | Visual | a*b* | L* | variation | transmittance | transmittance | Bending test | Heat cycle test |
| Example 1 | A | A | A | A | A | A | A | A |
| Example 2 | B | A | B | A | B | A | A | A |
| Example 3 | B | A | A | A | A | A | A | A |
| Example 4 | C | B | C | A | A | A | A | A |
| Example 5 | C | B | C | A | A | A | A | B |
| Example 6 | C | B | C | A | A | A | A | A |
| Example 7 | B | B | C | A | A | A | B | A |
| Example 8 | A | A | A | A | A | A | A | A |
| Example 9 | C | C | C | A | A | A | B | A |
| Example 10 | B | A | B | A | A | A | A | A |
| Example 11 | B | A | B | A | A | A | A | A |
| Example 12 | C | B | B | A | A | A | A | A |
| Example 13 | C | B | C | A | A | A | A | A |
| Example 14 | A | A | A | A | A | A | A | A |
| Example 15 | A | B | B | A | A | A | B | A |
| Example 16 | A | A | A | A | A | A | A | A |
| Example 17 | A | B | B | A | A | A | A | A |
| Comparison 1 | F | E | E | C | A | A | A | B |
| Comparison 2 | F | E | E | C | A | A | B | B |
| Comparison 3 | E | D | D | C | A | A | A | A |
| Comparison 4 | E | D | D | C | A | A | B | B |
| Comparison 5 | F | E | E | C | B | A | A | B |
| Comparison 6 | E | D | D | C | A | A | A | A |
| Comparison 7 | D | D | D | C | A | A | D | C |

As will be known from Table 3, all of the timepiece dials according to the present invention exhibit an outstanding appearance as well as outstanding transmittance of electromagnetic waves (radio waves and light) and durability.

Compared with these, satisfactory results were not obtained from the comparison samples. More specifically, an outstanding appearance, outstanding transmittance of electromagnetic waves, and durability suitable for a timepiece dial were not all simultaneously achieved by the timepiece dials in the comparison samples.

Timepieces as shown in FIG. 3 were also assembled using the timepiece dials described in each of the examples and the comparison samples. When these timepieces were tested and evaluated as described above, the results were the same as described above.

Note that “top,” “bottom,” “perpendicular,” “diagonal,” and other directional words used above refer to the directions in the accompanying figures. Words denoting direction that are used to describe the invention should therefore be interpreted in relation to the accompanying drawings.

In addition, “approximately” and other words denoting degree that are used above indicate a suitable variation to a degree not resulting in a major change. Such words denoting degree should be interpreted as including a difference of at least ±5% unless the deviation will result in a major change.

Furthermore, the embodiments described above are just some examples of the invention, and it will be obvious that the foregoing description will enable one skilled in the related art to modify the embodiments in various ways without departing from the scope of the present invention defined in the accompanying claims.

Furthermore, the foregoing embodiments are only to describe the invention, and do not limit the scope of the invention described in the scope of the following claims or an equivalent scope.

This specification claims priority based on Japan Patent Application 2006-339229, and incorporates the entirety of the disclosure in Japan Patent Application 2006-339229 herein by reference.

### APPLICATION IN INDUSTRY

A timepiece dial according to the invention includes a base member made of primarily polycarbonate, a titanium oxide particle dispersion layer having titanium oxide particles made of titanium oxide dispersed in a dispersion medium, and a silicon oxide particle dispersion layer having silicon oxide particles made of silicon oxide dispersed in a dispersion medium. As a result, a timepiece dial that has outstanding electromagnetic wave (radio waves and light) transmittance as well as an outstanding appearance and durability can be provided. The timepiece dial according to the invention therefore has industrial usability.

1. A timepiece dial comprising:
a base member made of primarily polycarbonate;
a titanium oxide particle dispersion layer having titanium oxide particles made of titanium oxide dispersed in a dispersion medium; and
a silicon oxide particle dispersion layer having silicon oxide particles made of silicon oxide dispersed in a dispersion medium.

2. The timepiece dial described in claim 1, wherein the average particle diameter of the titanium oxide particles is 2-30 nm.

3. The timepiece dial described in claim 1, wherein the content of the titanium oxide particles in the titanium oxide particle dispersion layer is 3-35 vol %.

4. The timepiece dial described in claim 1, wherein the titanium oxide is rutile titanium dioxide.

5. The timepiece dial described in claim 1, wherein the thickness of the titanium oxide particle dispersion layer is 0.5-30 μm.

6. The timepiece dial described in claim 1, wherein the average particle diameter of the silicon oxide particles is 10-250 nm.

7. The timepiece dial described in claim 1, wherein the content of the silicon oxide particles in the silicon oxide particle dispersion layer is 3-35 vol %.

8. The timepiece dial described in claim 1, wherein the thickness of the silicon oxide particle dispersion layer is 0.5-30 μm.

9. The timepiece dial described in claim 1, wherein when the average particle diameter of the titanium oxide particles is D_{TO} (nm) and the average particle diameter of the silicon oxide particles is D, (nm), the relationship 3·D_{SO}/D_{TO}·10 is true.

10. The timepiece dial described in claim 1, wherein the timepiece dial is used with the base member disposed on the viewer side of the silicon oxide particle dispersion layer.

11. The timepiece dial described in claim 1, wherein the silicon oxide particle dispersion layer is disposed on the surface on the opposite side of the base member as the surface to which the titanium oxide particle dispersion layer is disposed.

12. The timepiece dial described in claim 1, wherein the titanium oxide particle dispersion layer and the silicon oxide particle dispersion layer are adjoining.

13. The timepiece dial described in claim 1, further comprising in addition to the base member, the titanium oxide particle dispersion layer, and the silicon oxide particle dispersion layer, a reflective film having openings disposed therein.

14. The timepiece dial described in claim 1, wherein the base member has disposed on a second surface, which is on the surface on the opposite side as a first surface, which is the surface on the viewer side, fine pits and lands with a function of reflecting and scattering light incident from the first surface side.

15. The timepiece dial described in claim 1, wherein the color of the surface of the timepiece dial on the opposite side of the base member as the surface on the side to which the silicon oxide particle dispersion layer is disposed has an a* of −8 to 8 and a b* of −8 to 8 in the L*a*b* color space defined in JIS Z 8729.

16. A timepiece comprising the timepiece dial described in claim 1.
